(19) United States
(12) Patent Application Publication
(10) Pub. No.: US 2022/0395843 A1
(43) Pub. Date: Dec. 15, 2022

(54) CUP-SHAPED SHOWER JET OUTLET NOZZLE AND SHOWER DEVICE

(71) Applicant: Hansgrohe SE, Schiltach (DE)

(72) Inventors: Marcel Bilger, Rottweil (DE); Ulrich Kinle, Schenkenzell (DE); Markus Wõhrle, Schiltach (DE); Pascal Jonat, Hausach (DE)

(21) Appl. No.: 17/835,257

(22) Filed: Jun. 8, 2022

(30) Foreign Application Priority Data
Jun. 10, 2021 (DE) 102021205915.5

(51) Int. Cl. B05B 1/30; B05B 12/08

(52) U.S. Cl. CPC B05B 1/3006; B05B 12/088

(57) ABSTRACT

A shower jet outlet nozzle includes a hollow chamber (1), a lateral wall (2) delimiting the hollow chamber transversely to a nozzle longitudinal axis (D_{L}), and a bottom (3) delimiting the hollow chamber in the direction of the nozzle longitudinal axis on an outlet side, which bottom is made of an elastic material and in which a jet outlet opening structure (4_{S}) including one or a plurality of jet outlet openings (4) and having an open initial configuration, wherein the bottom is configured with the jet outlet opening structure thereof, under the effect of a shower fluid operating pressure in the hollow chamber, to deform in an elastically resilient manner and thereby to steadily increase an opening cross-section of the jet outlet opening structure with increasing shower fluid operating pressure within a normal operating pressure range. According to one aspect, the jet outlet opening structure (4_{S}) is spaced apart from the lateral wall (2), and the bottom (3) on an inner side (3_{I}) and/or on an outer side (3_{A}) has a weakening pattern (5) with a lesser wall thickness as compared to an adjacent region of the bottom, wherein the weakening pattern is designed to deform in an elastically resilient manner under the effect of the fluid operating pressure in the hollow chamber (1).

### CROSS-REFERENCE TO RELATED APPLICATION

This application claims priority to German Patent Application No. DE 10 2021 205 915.5, filed on Jun. 10, 2021, the disclosure of which is expressly incorporated herein by reference.

### BACKGROUND AND SUMMARY OF THE DISCLOSURE

The invention relates to a cup-shaped shower jet outlet nozzle which comprises a hollow chamber, a lateral wall delimiting the hollow chamber transversely to a nozzle longitudinal axis, and a bottom delimiting the hollow chamber in the direction of the nozzle longitudinal axis on an outlet side, which bottom is made of an elastic material and in which a jet outlet opening structure composed of one or a plurality of jet outlet openings and having an open initial configuration is provided, wherein the bottom is designed, with the jet outlet opening structure thereof, under the effect of a shower fluid operating pressure in the hollow chamber, to deform in an elastically resilient manner and thereby to steadily increase an opening cross-section of the jet outlet opening structure with increasing shower fluid operating pressure within a normal operating pressure range. The invention furthermore relates to a shower device comprising one or a plurality of shower jet outlet nozzles of this kind.

Shower jet outlet nozzles of this and similar types are widely used in shower devices, in particular sanitary shower devices. The elastically resilient deformability of the bottom can be used for different purposes. In the case of the said generic nozzle type, the jet outlet opening structure composed of the jet outlet opening or the jet outlet openings has an open initial configuration, this meaning that the jet outlet opening structure already has an open configuration, i.e. one that allows the passage of fluid, in the pressureless initial situation, in which no fluid pressure or at least no appreciable fluid pressure is applied in the nozzle hollow chamber. In other words, the opening cross-section of the jet outlet opening structure, i.e. the effective passage cross-section thereof required for the passage of shower fluid, is already greater than zero in the pressureless initial state, in contrast to other kinds of nozzles which are closed in the pressureless initial configuration and open only due to fluid pressure being applied.

In the present case, shower fluid operating pressure is to be understood to mean, as the name suggests, the pressure of the shower fluid during operation of the shower jet outlet nozzle, with this relating to intended, normal operation of the nozzle and not to specific situations, such as e.g. overpressure situations, in which the pressure of the shower fluid in the nozzle hollow chamber rises beyond a normal operating pressure range, e.g. on account of blockages in the jet outlet opening structure. More precisely, the shower fluid operating pressure refers to that fluid pressure during normal shower operation of the nozzle which prevails in the hollow chamber of the nozzle, for which reason it is also referred to as the nozzle internal pressure or internal pressure for short. Here, the normal operating pressure range refers to the pressure range in which the fluid pressure lies or can lie during normal operation of the nozzle depending on the current operating environment. Therefore, the actual fluid operating pressure may depend e.g. on country- or region-specific regulations or conditions of an associated fluid supply, such as a public water supply, but also on the design of the shower in question and the use state thereof. In the case of sanitary shower devices which are connected to public water supplies, the supply pressure available in buildings for example typically lies in a range of from approximately 0.5 bar to approximately 1.5 bar, and the shower fluid operating pressure in the nozzle hollow chamber, i.e. the nozzle internal pressure, then assumes e.g. values in the range of from 0 bar to approximately 0.4 bar, usually between approximately 0.2 bar and 0.4 bar, during normal operation. A nozzle internal pressure of more than approximately 0.5 bar, as may occur in the case of conventional shower devices e.g. on account of nozzle blockages, is generally undesirable for sanitary shower devices owing to the associated risk of damage to the nozzle or to the shower device due to the pressure loading, and therefore this is counteracted e.g. by the installation of overpressure valves.

A shower jet outlet nozzle of this generic type is disclosed in laid-open publication US 2003/0062426 A1. In the case of this nozzle, the bottom is formed by e.g. three or four flap parts which protrude radially inwards from the lateral wall at the nozzle outlet and define a single jet outlet opening of the nozzle between then. During shower device operation, the flap parts bend open radially and axially, i.e. parallel to the nozzle longitudinal axis, in an elastically resilient manner to the outside under the effect of the fluid operating pressure in the hollow chamber by an extent dependent on the shower fluid operating pressure level. In the pressureless initial configuration, the jet outlet opening is composed of a relatively small central opening and slit regions leading away from the central opening in the form of rays radially outwards up to the lateral wall, the slit regions each keeping adjacent flap parts separate from one another, i.e. the jet outlet opening has a star- or cross-like basic shape. Owing to the flap parts folding open when fluid operating pressure is applied, the opening cross-section of the jet outlet opening increases, as a result of which the flow resistance of the nozzle should be automatically adapted to different fluid flow rates. In the process, the cross-sectional shape of the jet outlet opening qualitatively changes to a more circular shape. As an alternative, cylindrical nozzles without a bottom are proposed in the said document, these being able to deform in an elastically resilient manner by way of their lateral wall under the effect of the fluid operating pressure, the lateral wall being provided with axial slits for this purpose.

In the case of a cup-shaped shower jet outlet nozzle disclosed in laid-open publication DE 10 2016 225 987 A1, a plurality of jet outlet openings in the form of fine jet openings are formed in a bottom composed of elastic material, which bottom deforms in a bulging manner under the effect of the shower fluid operating pressure applied in the hollow chamber, and, in addition to the bottom, the lateral wall is preferably also formed from elastic material and configured in such a way that it deforms in a bulging manner depending on the fluid pressure, just like the bottom. The intention with this nozzle configuration is to be able to produce a mist-like fine shower jet together with relatively low sensitivity to blockages due to particles of dirt and lime deposits.

In the case of a shower head disclosed in laid-open publication DE 40 39 337 A1, cup-shaped, cylindrical elastic jet-forming units, the bottom thereof being provided with an individual circular jet outlet opening with a diameter of approximately 1.2 mm, are inserted into circular receiving openings with a diameter of approximately 2 mm to 10 mm of a rigid jet disc with an accurate fit. When fluid operating pressure is applied, the bottom can deform in an outwardly bulging manner, as a result of which lime deposits should automatically flake off or fall off.

Furthermore, various embodiments of shower jet outlet nozzles are known, in which a lateral wall and possibly an optionally present bottom composed of elastic material are designed to be deformed only by pressure exerted by the user, in particular in order to remove lime deposits. In contrast, the nozzles and in particular the jet outlet opening thereof should remain dimensionally stable under the shower fluid operating pressure applied during operation of the shower device and therefore not deform, in order to ensure a constant jet characteristic of the emitted shower jet, for which purpose the lateral wall thereof and the optional bottom thereof are designed with a corresponding pressure resistance. Laid-open publication WO 95/22407 A1 discloses a cup-ring-shaped shower jet outlet nozzle of this kind composed of elastic material, with the possibility of a cup ring bottom of the nozzle bulging outwards owing to the shower fluid operating pressure applied in the case of an inwardly bulging or flat design additionally being mentioned there.

Furthermore, shower jet outlet nozzles are known, the jet outlet opening structure thereof not being formed with an open initial configuration, but rather a closed initial configuration, i.e. the opening cross-section thereof is equal to zero in the pressureless initial configuration, with the jet outlet opening structure then only opening under the effect of the shower fluid operating pressure. A shower jet outlet nozzle of this type is disclosed in laid-open publication EP 1 700 636 A2. In the case of the nozzle in that application, the respective jet outlet opening is formed or covered by an elastic closure diaphragm which is provided with slit patterns which are closed in the pressureless state, by way of which the closure membrane can open in a deforming manner under the effect of fluid pressure. In the case of sanitary shower devices, this type of nozzle is typically used to prevent the undesired effect of dripping. A further shower jet outlet nozzle of this type is disclosed in laid-open publication DE 31 07 808 A1.

It is an object of the invention to provide a shower jet outlet nozzle of the kind mentioned at the outset which is further improved in comparison to the abovementioned prior art, in particular in respect of the shower jet characteristic it can provide at different shower fluid operating pressure levels and preferably also in respect of producing a relatively fine shower jet, a low tendency to form lime and a reasonably low level of expenditure on production. Furthermore, the invention is directed at providing a corresponding shower device.

The invention achieves this and other objects by providing a shower jet outlet nozzle having the features mentioned at the outset in combination with additional favorable features. Advantageous developments of the invention are specified in the dependent claims, the wording of which is hereby made part of the description by reference. This in particular also includes all of the embodiments of the invention that arise from the combinations of features which are defined by the dependency references in the dependent claims.

According to a first aspect of the invention, in the case of the shower jet outlet nozzle according to the invention, the jet outlet opening structure is spaced apart from the lateral wall, and the bottom on an inner side and/or on an outer side has a weakening pattern with a lesser wall thickness as compared to an adjacent region of the bottom, wherein the weakening pattern is designed to deform in an elastically resilient manner under the effect of the fluid operating pressure in the hollow chamber.

It has been found, in a manner verifiable by computer simulation and/or experimental tests that this measure highly advantageously contributes to the shower jet outlet nozzle configured in this way being able to provide and maintain desired shower jet characteristics for different fluid operating pressure levels. In particular, this measure helps in providing the desired steady increase in the opening cross-section of the jet outlet opening structure with increasing shower fluid operating pressure and at the same time in influencing, e.g. qualitatively largely maintaining or alternatively changing in a desired manner, the cross-sectional shape of the jet outlet opening structure in a defined manner with a shower fluid operating pressure which changes within the normal operating pressure range. This contributes to achieving, e.g. maintaining or changing in a targeted manner, a respectively desired shower jet characteristic, i.e. a desired jet type or a desired jet characteristic of the shower jet, in different normal operating situations in which different shower fluid operating pressures are present in the hollow chamber of the nozzle, e.g. owing to different water pressures in various water supply networks or owing to brief fluctuations in the supply water pressure or owing to different shower fluid volume flows, as can be variably specified by the user e.g. at an upstream shut-off fitting, and the changes in the shower fluid operating pressure in the nozzle hollow chamber required as a result.

Since the jet outlet opening structure is spaced apart from the lateral wall of the nozzle, all the associated jet outlet openings are located within a region of the bottom spaced apart from the nozzle lateral wall, as a result of which it is possible for the shape-stabilizing effect of the lateral wall to be transmitted to the bottom particularly well. The weakening pattern in the bottom allows targeted prespecification of the type and the extent of elastically resilient deformation under the effect of fluid pressure. The bottom is more readily deformable in the region of the weakening pattern, on account of its lower wall thickness, than in the adjoining bottom region of greater wall thickness, and therefore the fluid pressure-dependent deformation of the bottom can be influenced in a targeted manner and therefore can be determined by defined configuration of the weakening pattern in respect of shaping and wall thickness. In particular, the bottom can be formed by corresponding configuration of the weakening pattern as required in such a way that firstly, as required, the opening cross-section of the jet outlet opening structure steadily increases with increasing shower fluid operating pressure within the normal operating pressure range and secondly the cross-sectional shape of the jet outlet opening structure remains readily controllable, e.g. remains largely unchanged or undergoes a prespecified change in shape, with shower fluid operating pressure changing within the normal operating pressure range. For the nozzle, this advantageously results in a significantly flatter characteristic curve for the increase in the fluid pressure in the nozzle, in comparison to conventional, rigid nozzles designed to not deform depending on fluid pressure, with an increasing volume flow of shower fluid passing through the nozzle and at the same time the cross-sectional shape of the jet outlet opening structure can be qualitatively maintained, depending on requirements and the application, or can also be variably prespecified in a targeted manner depending on the fluid pressure for specific cases. In this case, the weakening pattern can in particular contribute to achieving a desired high degree of steadiness of the dependency of the bottom deformation and as a result the widening of the respective jet outlet opening on the increase in the nozzle internal pressure, this preventing sudden changes in the cross-sectional shape and the opening cross-section of the jet outlet opening when the nozzle internal pressure changes.

According to a second aspect of the invention, the jet outlet opening structure of the shower jet outlet nozzle according to the invention comprises at least one jet outlet opening having an opening radius increasing and decreasing alternatingly in the circumferential direction, while forming alternate bulge regions and recess regions, wherein the bulge regions each have a rounded shape with a respective minimum bulge curvature radius and the recess regions each have a rounded shape with a respective minimum recess curvature radius. In this case, the minimum bulge curvature radii and the minimum recess curvature radii are in a range between 0.01 mm and 1 mm. In addition or as an alternative to this dimensioning property, the minimum bulge curvature radii are in a size ratio between 0.3 and 2.5 to the minimum recess curvature radii. In this case, when the jet outlet opening structure comprises a plurality of jet outlet openings, all of these jet outlet openings, or only some of them, can have such a shape with bulge regions and recess regions.

It is found, once again in a manner verifiable by computer simulation and/or experimental tests, that the jet outlet opening structure configured in this way allows particularly advantageous shower jet characteristics to be achieved. Here, it has been found, amongst other things, that the alternating sequence of bulge regions and recess regions and the respectively sufficiently rounded shape thereof with the indicated minimum curvature radii or with the size ratio not differing too greatly from a value of one, which specifically lies between 0.3 and 2.5, contributes to the advantageous shower jet characteristics of the jet outlet opening in question, wherein it is additionally found that, owing to this configuration of the jet outlet opening, desired, consistently expedient shower jet characteristics can be achieved over a wide range of possible shower fluid operating pressures and not only for an extremely specific shower fluid operating pressure or a narrow sub-range of the shower fluid operating pressure within a range of relevant shower fluid operating pressures occurring in practice. In this case, a jet characteristic which is advantageous in a non-predictable, surprising manner can be impressed on the shower jet by the jet outlet opening with its rounded bulge and recess regions and also can be largely maintained over the wide normal operating pressure range of possible fluid pressures and resulting cross-sectional shapes of the jet outlet opening of different widths. The shower jet exiting from this jet outlet opening is able to largely maintain its jet shape over a relatively long distance after leaving the jet outlet opening, without breaking down into individual jets or droplets as early as after a short distance. This can be attributed to a correspondingly positive influence of the rounded bulge and recess regions of the jet outlet opening on the flow ratios in the shower jet with which e.g. turbulences and singularities of the shower fluid flow which could be caused by pointed or angled regions of the opening edge of the jet outlet opening are avoided. Secondly, it may be the case that minimum recess curvature radii or minimum bulge curvature radii of more than 1 mm hamper the deformation of the bottom in the region of the jet outlet opening and therefore do not yield the desired advantages for certain applications.

According to a third aspect of the invention, the jet outlet opening structure of the shower jet outlet nozzle according to the invention comprises at least one jet outlet opening having a non-planar opening edge which is undulated extending with an axial directional component pointing in a fluid outlet direction and counter to the fluid outlet direction relative to a plane of the bottom. In this case, the fluid outlet direction is understood to mean the direction of the nozzle longitudinal axis pointing out of the nozzle, where the shower fluid leaves the nozzle with a directional component pointing in this fluid outlet direction, in most cases with a main directional component pointing in this direction, i.e. parallel to this or at an acute angle of less than 45° to this. In this case, if the jet outlet opening structure comprises a plurality of jet outlet openings, all of these jet outlet openings, or only some of them, can have such a non-planar opening edge.

It is found, once again in a manner verifiable by computer simulation and/or experimental tests, that this configuration of the jet outlet opening in question likewise contributes to both providing the desired steady increase in the opening cross-section of the jet outlet opening and therefore the jet outlet structure overall with shower fluid operating pressure increasing within a normal operating pressure range in an expedient manner and also being able to provide expedient shower jet characteristics for different shower fluid operating pressures within the normal operating pressure range, be it in respect of keeping the cross-sectional shape of the jet outlet opening structure and resulting shower jet characteristics largely constant over the normal operating pressure range or being able to change them in a targeted manner in a desired way, in each case achieved by a corresponding specific design of the non-planar opening edge of the jet outlet opening in question. Owing to the undulating course thereof in respect of its axial directional component parallel to the nozzle longitudinal axis, according to which the opening edge, as it runs around the opening circumference, runs with a steadily changing axial directional component alternately in the direction to the outside from the nozzle hollow chamber and in the direction to the inside into the nozzle hollow chamber, the result is a highly elastic deformability of the nozzle bottom, desired for the change in the opening cross-section of the jet outlet opening while qualitatively maintaining its cross-sectional shape, and therefore the jet outlet opening structure thereof over a wide range of different shower fluid operating pressures, with a very uniform deformation behaviour, i.e. a high degree of steadiness thereof, with a changing nozzle internal pressure being able to be achieved.

It has been found that the three abovementioned aspects of the invention each on their own and, as is understood by a person skilled in the art on the basis of the given information and explanations, in any desired combination of in each case two or all three aspects contribute to providing a shower jet outlet nozzle which allows significant advantages over the shower jet outlet nozzles of the prior art mentioned at the outset, in particular in respect of the shower jet characteristics that can be provided by it even with noticeably different shower fluid operating pressures within a customary normal operating pressure range in the nozzle hollow chamber. Each of these aspects of the invention additionally contributes to keeping the tendency of the shower jet outlet nozzle to form lime low, in particular owing to the elastic deformation of the nozzle bottom which is variable depending on the fluid pressure and prevents accumulation of lime and can automatically remove any accumulation of lime again, and if required being able to generate a relatively fine nozzle jet, for which purpose the respective jet outlet opening can be configured with a correspondingly small opening cross-section. The shower jet outlet nozzle according to the invention can additionally be manufactured with a comparatively low level of expenditure in any of the three aspects of the invention mentioned and is, for example, highly suitable for sanitary shower devices, such as for showering devices in the form of overhead, handheld and side shower devices in shower rooms and for kitchen spray devices, as are used at kitchen workstations.

The jet producing behaviour or the shower jet outlet characteristics of the shower jet outlet nozzle according to the invention can be optimally adapted to different fluid pressures, as can occur during normal shower device operation, e.g. to different prespecified fluid pressures in different water supply networks of different countries or regions and likewise to operation-related fluctuations in the fluid pressure of a water supply or another fluid supply and to any fluctuations in fluid pressure during normal shower device operation which may occur in an associated shower device itself. One particular advantage, amongst others, is that in the case of the shower jet outlet nozzle according to the invention the shower fluid operating pressure, i.e. the internal pressure of the shower fluid in the nozzle hollow chamber and especially in the vicinity of the nozzle outlet, increases considerably less severely with increasing volume flow of shower fluid passing through the nozzle than is the case in conventional shower jet outlet nozzles which have a similar construction but are designed as rigid nozzles which do not noticeably deform under the fluid pressure during normal shower device operation.

In other words, a considerably flatter characteristic curve for the internal pressure as a function of the volume flow is obtained for the shower jet outlet nozzle according to the invention in comparison to the said conventional nozzles. In other words, the shower jet outlet nozzle according to the invention allows comparatively high volume flows of fluid passing through the nozzle given a fluid internal pressure in the nozzle hollow chamber which remains comparatively low. The shower jet outlet nozzle according to the invention therefore allows both relatively low and also relatively high volume flows preferably while largely maintaining the shower jet characteristics or the jet characteristic of the shower jet emitted by the said shower jet outlet nozzle and without an undesirably sharp increase in the fluid pressure in the nozzle hollow chamber.

In one development of the invention, the weakening pattern includes at least one weakening zone in the bottom, which extends from an associated jet outlet opening of the jet outlet opening structure away from the latter. If the weakening pattern comprises a plurality of weakening zones, this feature is realized in all of these weakening zones or only in some of them, as required. The extent of the weakening zone in which the bottom is particularly readily deformed up to the jet outlet opening has proven to be advantageous for a very large number of applications in respect of a desired expanding deformation of the jet outlet opening with increasing shower fluid operating pressure in the nozzle hollow chamber. In alternative embodiments, as may be expedient for certain other applications, the weakening zone or the weakening zones of the weakening pattern keeps/keep a certain minimum distance from the jet outlet opening or the opening edge thereof.

In one refinement of the invention, the weakening zone in the bottom is a linear, i.e. line-shaped, weakening zone extending with a radial main directional component in a straight line or single-bent or multiple-bent in undulated lines. This measure has proven to be expedient for further optimizing the bottom deformation behaviour for a very large number of applications. The course of the linear weakening zone in a direction radial with respect to the bottom or the jet outlet opening or in a predominantly radial direction contributes to an expedient deformation behaviour for the purposes of achieving desired influencing of the cross-sectional shape of the jet outlet opening which widens with a higher fluid pressure. A straight course of the weakening zone can additionally simplify manufacture. A single-bent or a multiple-bent course in undulating lines allows even greater deformation of the bottom and therefore its jet outlet opening structure over a comparatively large range of possible shower jet fluid operating pressures in comparison to a straight course. In addition, the bottom can deform in the region of the jet outlet opening with an additional rotational component about the longitudinal axis of the jet outlet opening in this way as required. In alternative embodiments, as may be expedient for corresponding applications, the weakening zone can have e.g. a helical course with a radial minority directional component, i.e. it then extends with a smaller directional component radially and with a main directional component in a direction perpendicular to the radial direction.

In one refinement of the invention, the weakening zone in the bottom extends up to the lateral wall and there transitions into a weakening zone in the lateral wall. Owing to this measure, the lateral wall, in particular in its region adjoining the bottom, can contribute to the deformation behaviour of the bottom as required since the additional weakening zone in the lateral wall means a certain weakening for the lateral wall and its shape-stabilizing effect on the bottom. Depending on the design of this additional weakening zone in the lateral wall, the deformation of the bottom can additionally also be accompanied by a supplementary deformation of the lateral wall. In alternative embodiments in which there is no need for this functionality of the lateral wall, the lateral wall is realized without a weakening zone.

In one refinement of the invention, the weakening zone in the bottom is a linear weakening zone departing from one of the bulge regions or one of the recess regions of the associated jet outlet opening. This measure can advantageously contribute to influencing the cross-sectional shape of the jet outlet opening in a targeted manner in the event of widening of the jet outlet opening by increased deformation of the bottom as the shower fluid operating pressure rises, e.g. qualitatively maintaining a prespecified cross-sectional shape, and/or to influencing or aiding the widening of the jet outlet opening in a targeted manner with a higher fluid pressure, especially in the region of its bulge regions or its recess regions. In alternative embodiments, as may be expedient for corresponding applications, the weakening zone does not depart from bulge or recess regions of the jet outlet opening, e.g. in cases in which the jet outlet opening does not have such bulge and recess regions, or in cases in which the weakening zone departs in a section of the jet outlet opening outside the bulge regions and recess regions thereof.

In one refinement of the invention, the bottom for the jet outlet opening, away from which opening the at least one weakening zone extends, is disposed in a jet angle setting manner, wherein the one or more weakening zones extending away from the jet outlet opening on the inner side of the bottom are disposed in an asymmetric arrangement in a jet angle setting manner relative to a longitudinal central plane of the jet outlet opening, and/or the bottom, at least in a region including the jet outlet opening, extends inclined on the inner side in a jet angle setting manner, and/or the jet outlet opening in the bottom is disposed eccentrical in a jet angle setting manner.

In the present case, the specification that the bottom for the jet outlet opening is disposed in a jet angle setting manner is to be understood to mean that in this case the bottom is disposed in such a way that a jet angle setting is produced for the jet outlet opening, i.e. during operation of the nozzle the shower jet exits from this jet outlet opening at a jet angle which is set with respect to the longitudinal axis of the nozzle, i.e. forms an acute angle with it. This acute angle or setting angle typically lies e.g. in a range between 0° and 30°, usually between 0° and 20°, e.g. between 5° and 15°, for sanitary shower applications.

In the present case, this jet angle setting is advantageously provided by the corresponding design of the bottom, in particular by corresponding asymmetric arrangement of its inner-side weakening zone or zones and/or by a correspondingly inclined course of its bottom inner side and/or by corresponding eccentric arrangement of the jet outlet opening. These measures, on their own or in combination, contribute to the shower fluid entering the jet outlet opening with a higher flow rate and here also a higher transverse component of the flow rate perpendicularly to the nozzle longitudinal axis on one side of the longitudinal central plane of the jet outlet opening than on the other, opposite side, this resulting in the effect that the shower jet does not exit from the jet outlet opening parallel to the nozzle longitudinal axis, but rather at the said setting angle.

Therefore, the weakening zones on the inner side of the bottom can act as ducts for the shower fluid, with the asymmetric arrangement thereof ensuring that there is a higher flow rate for the shower fluid in relation to the longitudinal central plane of the jet outlet opening on one side than on the opposite side, this resulting in the shower fluid not exiting from the jet outlet opening in parallel, but rather inclined, with respect to this longitudinal central plane, i.e. at the said setting angle with respect to the nozzle longitudinal axis. The same or a similar effect can be achieved by disposing the bottom inner side in an inclined manner or by the eccentric arrangement of the jet outlet opening in the bottom.

It has been found here that this bottom design means the setting angle for the shower jet remains largely constant with a changing shower fluid operating pressure and resulting deformation of the bottom and widening or narrowing of the jet outlet opening to an unexpected extent. In other words, the desired setting angle remains substantially unchanged both for operating states with relatively small volume flows of fluid passing through the nozzle and for operating states with relatively high volume flows. In alternative embodiments, the nozzle is realized with its bottom without such jet angle setting, i.e. the shower jet exits from the nozzle with a jet main direction parallel to the nozzle longitudinal axis in this case.

In a further refinement of the invention, the asymmetric arrangement of the one or more weakening zones extending away from the jet outlet opening on the inner side of the bottom comprises two linear weakening zones opposed to each other in relation to the longitudinal central plane having different lengths and/or different widths, or comprises a weakening zone extending away from the jet outlet opening on the inner side of the bottom, with a non-weakened bottom zone opposed thereto in relation to the longitudinal central plane of the jet outlet opening. This constitutes a functionally highly effective possible way of realizing the desired jet angle setting for the jet outlet opening by a specific asymmetric arrangement of the one or more associated weakening zones in a relatively simple manner in terms of production. As an alternative, other embodiments for this asymmetrical arrangement are possible, e.g. using correspondingly asymmetrically arranged flat, rather than linear, weakening zones.

In a development of the invention, the weakening pattern includes in each case at least one weakening zone on the inner side and on the outer side of the bottom, wherein the at least one weakening zone on the inner side is disposed offset in relation to the at least one weakening zone on the outer side in the circumferential direction of the bottom. This measure proves advantageous, for example, for applications in which a comparatively large amount of deformability of the bottom is desired, i.e. that the bottom should deform to a relatively great extent at the given fluid pressure. This is achieved by the weakening of the bottom on both sides which allows the bottom to be deformed more easily than if only the weakening zone on the inner side or only the weakening zone on the outer side is present. Since the weakening zones on either side are offset in relation to one another in the bottom circumferential direction, they do not affect one another and therefore can be made in the bottom e.g. as recesses which have a depth of approximately half the wall thickness of the bottom or more. Conversely, the formation of the weakening zones on both sides of the bottom requires less wall weakening of the bottom than formation of the weakening pattern only on the inner side or only on the outer side of the bottom for achieving a desired amount of deformation at a specific fluid pressure. In alternative embodiments in which this is adequate and expedient, the weakening pattern is formed only on the inner side or only on the outer side of the bottom.

In a development of the invention, the jet outlet opening structure has a jet outlet opening with a rounded polygonal cross-sectional base shape, wherein the bulge regions form rounded corner regions of the polygonal cross-sectional base shape. In this case, if the jet outlet opening structure comprises a plurality of j et outlet openings, all of these jet outlet openings, or only some of them, have such a cross-sectional base shape. It has been found that this choice of the cross-sectional base shape for the respective jet outlet opening leads to a jet characteristic of the shower jet exiting from the jet outlet opening which is optimal for most applications, in particular in sanitary shower devices, under the various shower fluid operating pressures within the normal operating pressure range. Here, the cross-sectional base shape may be, in particular, a rectangular or triangular cross-sectional base shape and for some applications even a polygonal cross-sectional base shape with more than four rounded corner regions or recess regions, e.g. one with five or six rounded corner regions.

In a development of the invention, the jet outlet opening structure has a jet outlet opening with an outlet equivalent diameter in a range of 0.2 mm to 1.2 mm. This is understood to mean that the jet outlet opening is formed with an opening cross-section which corresponds to the opening cross-section of an imaginary circular jet outlet opening with an opening diameter between 0.2 mm and 1.2 mm. The jet outlet opening is accordingly a jet outlet opening with a relatively small opening cross-section in comparison to jet outlet openings of conventional sanitary shower devices. Jet outlet openings of this kind produce a correspondingly fine shower jet which is therefore also referred to as a needle jet or fine jet by a person skilled in the art. This dimensioning applies in respectively corresponding implementations for all jet outlet openings of the bottom or the nozzle or only for one of a plurality of jet outlet openings or only for some of all the jet outlet openings. In alternative embodiments, each jet outlet opening has an outlet equivalent diameter of more than 1.2 mm or even less than 0.2 mm.

In one development of the invention, a wall thickness of the bottom outside the weakening pattern is in a range of 0.1 mm to 1 mm. This thickness dimensioning of the bottom proves to be advantageous in respect of adequate pressure stability of the bottom on the one hand and its desired fluid pressure-dependent deformability on the other for the majority of applications, in particular in sanitary shower devices. In alternative embodiments, the thickness of the bottom wall outside the weakening pattern is less than 0.1 mm or more than 1 mm for specific applications.

In one development of the invention, a minimum wall thickness of the bottom in the region of the weakening pattern is between one fifth and half of a wall thickness of the bottom outside the weakening pattern. This constitutes an optimum ratio for the wall thickness of the bottom in the weakened region on the one hand and in the non-weakened region on the other for many applications, in particular in sanitary shower devices, for satisfying the required properties in respect of stability on the one hand and deformability on the other. In alternative embodiments, as may be expedient for specific applications, this ratio is less than one fifth or greater than 0.5.

In one development of the invention, the jet outlet opening structure has a jet outlet opening with a funnel-type quadrant-shaped rounded inlet region which has an inlet curvature radius between 0.1 mm and 0.3 mm. In this case, if the jet outlet opening structure comprises a plurality of jet outlet openings, all of these jet outlet openings, or only some of them, can have such an inlet region. This configuration and dimensioning of the inlet region of the jet outlet opening has proven advantageous in respect of the jet characteristics, provided by the jet outlet opening, of the shower jet emitted by it. In particular, the shower jet exiting from this jet outlet opening has proven to be comparatively stable, i.e. it largely maintains its jet shape over a relatively long distance after leaving the jet outlet opening, without for example separating into a plurality of individual jets or breaking down into droplets. In alternative embodiments, the said inlet curvature radius is selected to be less than 0.1 mm or greater than 0.3 mm if the associated jet characteristic for the shower jet is acceptable for the given application.

In one development of the invention, a hollow chamber inner diameter is in a range of 1.5 mm to 4 mm. This dimensioning measure for the nozzle proves to be advantageous in respect of the shower jet rendered possible as a result for a large number of applications, especially in sanitary shower devices. In alternative embodiments, the hollow chamber inner diameter of the nozzle can also be selected to be less than 1.5 mm or greater than 4 mm for certain applications.

In one development of the invention, a hollow chamber length of the nozzle is in a range of 4 mm to 8 mm. This also constitutes a dimensioning measure for the nozzle which has proven advantageous for numerous applications, in particular in sanitary shower devices. As an alternative, the hollow chamber length can also be selected to be less than 4 mm or greater than 8 mm if this appears to be expedient for specific applications.

In one development of the invention, a wall thickness of the lateral wall is at least 0.8 mm. This dimensioning measure for the lateral wall results in a desired adequate stability of the lateral wall which, in the case of the shower jet outlet nozzle according to the invention, functions primarily as a bottom-stabilizing element and, in contrast to the bottom, is not intended to deform or at least to not deform to an appreciable extent under the fluid operating pressures occurring during normal operation. It goes without saying that this wall thickness information relates to the wall thickness of the lateral wall outside the weakened region in cases in which the lateral wall also has a weakening region or a weakening pattern. In alternative embodiments, provision can be made to design the lateral wall with a wall thickness of less than 0.8 mm for specific applications.

In one development of the invention, the jet outlet opening structure comprises a plurality of jet outlet openings and the bottom comprises a reinforcing bar pattern having a greater wall thickness as compared to an adjacent region of the bottom, wherein the reinforcing bar pattern subdivides the bottom into a plurality of bottom partial regions, in which in each case at least one of the jet outlet openings is disposed, or extends with one respective reinforcing bar end up to a corresponding one of the jet outlet openings.

This measure is advantageous for specific applications in which the bottom is provided with a plurality of jet outlet openings. In the former case, the reinforcing bar pattern subdivides the bottom into partial regions in which in each case one or more of the jet outlet openings are then located. In the bottom partial regions, the bottom is in each case correspondingly deformable depending on the shower fluid operating pressure, in order to effect the desired change in the opening cross-section of the one or more jet outlet openings there, while the reinforcing bar pattern contributes to providing the bottom with adequate stiffness and therefore pressure stability overall in spite of the deformability of its partial regions. In the other case, one respective bar of the reinforcing bar pattern extends up to one of the jet outlet openings. In this case too, the reinforcing bar pattern contributes to providing the bottom, which deforms under the shower fluid operating pressure and is provided with a plurality of jet outlet openings, with adequate inherent stability. In alternative embodiments, the reinforcing bar pattern is dispensed with, in particular in cases in which the bottom has only one single jet outlet opening or, in spite of a plurality of jet outlet openings made therein and any associated weakening zones, also has adequate inherent stability without such a reinforcing bar pattern.

The shower device according to the invention has one or more shower jet outlet nozzles according to the invention. This shower device may be, in particular, a sanitary overhead, handheld or side shower device of a showering device or a kitchen spray device at a kitchen workstation. As an alternative, the shower device may also be a non-sanitary shower device, e.g. in chemical plant engineering for sensory addition of liquid or gaseous media. The shower device preferably comprises a plurality of shower jet outlet nozzles which are further preferably all realized by a shower jet outlet nozzle according to the invention.

Additional features and advantages of the present invention will become apparent to those skilled in the art upon consideration of the following detailed description of the illustrative embodiments best exemplifying the best mode of carrying out the invention as presently perceived.

### BRIEF DESCRIPTION OF THE DRAWINGS

Advantageous embodiments of the invention are illustrated in the drawings. These and further embodiments of the invention are described in greater detail below. In the drawings:

FIG. 1 shows a front-side perspective view of a cup-shaped shower jet outlet nozzle with a cruciform jet outlet opening;

FIG. 2 shows a plan view of the nozzle from FIG. 1 from the rear, i.e. from above in FIG. 1;

FIG. 3 shows a longitudinal sectional view of the nozzle from FIG. 1 along a line III-III in FIG. 2;

FIG. 4 shows a view of a detail of a central bottom region IV in FIG. 2;

FIG. 5 shows a view of a detail of a region V from FIG. 3;

FIG. 6 shows a perspective longitudinal sectional view of a variant of the nozzle of FIGS. 1 to 5 with a weakening pattern on the inner side of the bottom;

FIG. 7 shows a plan view of the nozzle of FIG. 6 from the rear, i.e. from above in FIG. 6;

FIG. 8 shows the perspective longitudinal sectional view from FIG. 6 for a nozzle variant with an additional lateral wall weakening pattern;

FIG. 9 shows a plan view of the nozzle of FIG. 8 from the rear;

FIG. 10 shows the perspective longitudinal sectional view from FIG. 6 for a nozzle variant with a weakening pattern on the outer side of the bottom;

FIG. 11 shows a perspective view of a detail of the nozzle of FIG. 10 from the front;

FIG. 12 shows the perspective longitudinal sectional view from FIG. 6 for a nozzle variant with a modified weakening pattern on the inner side of the bottom;

FIG. 13 shows a plan view of the nozzle of FIG. 12 from the rear;

FIG. 14 shows the perspective longitudinal sectional view from FIG. 6 for a further nozzle variant with a modified, bent weakening pattern on the inner side of the bottom;

FIG. 15 shows a plan view of the nozzle of FIG. 14 from the rear;

FIG. 16 shows the perspective longitudinal sectional view from FIG. 6 for a further nozzle variant with a modified weakening pattern in undulating lines on the inner side of the bottom;

FIG. 17 shows a plan view of the nozzle of FIG. 16 from the rear;

FIG. 18 shows the perspective longitudinal sectional view from FIG. 6 for a further nozzle variant with a modified weakening pattern in undulating lines on the inner side of the bottom;

FIG. 19 shows a plan view of the nozzle from FIG. 18 from the rear;

FIG. 20 shows the perspective longitudinal sectional view from FIG. 6 for a nozzle variant with a modified cross-sectional shape of the jet outlet opening;

FIG. 21 shows a plan view of the nozzle of FIG. 20 from the rear;

FIG. 22 shows the perspective longitudinal sectional view from FIG. 6 for a nozzle variant with a jet outlet opening with a non-planar opening edge in undulating lines;

FIG. 23 shows a perspective view of a detail of the nozzle of FIG. 22 from the front;

FIG. 24 shows a plan view of a detail of a central bottom region of the nozzle of FIGS. 22 and 23 with the jet outlet opening from the front;

FIG. 25 shows a plan view of a nozzle variant with a jet angle setting, asymmetric weakening pattern on the inner side of the bottom with a single linear weakening zone from the rear;

FIG. 26 shows a longitudinal sectional view of a front region of the nozzle from FIG. 25 with the jet angle setting functionality illustrated;

FIG. 27 shows a plan view of a further nozzle variant with a jet angle setting, asymmetric weakening pattern on the inner side of the bottom with three linear weakening zones from the rear;

FIG. 28 shows a plan view of a further nozzle variant with a jet angle setting, asymmetric weakening pattern on the inner side of the bottom with four linear weakening zones from the rear;

FIG. 29 shows a plan view of a further nozzle variant with an eccentric jet outlet opening and a jet angle setting, asymmetric weakening pattern on the inner side of the bottom with linear weakening zones of unequal length from the rear;

FIG. 30 shows a perspective longitudinal sectional view of a front region of a nozzle variant with an oblique bottom inner side and a jet angle setting, asymmetric weakening pattern on the inner side of the bottom with linear weakening zones of unequal length;

FIG. 31 shows a plan view of the nozzle from FIG. 30 from the rear;

FIG. 32 shows a plan view of a further nozzle variant with a jet angle setting, asymmetric weakening pattern on the inner side of the bottom with linear weakening zones of unequal length from the rear;

FIG. 33 shows a plan view of a further nozzle variant with a jet angle setting, asymmetric weakening pattern on the inner side of the bottom with linear weakening zones of unequal width from the rear;

FIG. 34 shows a plan view of a nozzle variant with three cruciform jet outlet openings in the bottom and a reinforcing bar pattern from the rear;

FIG. 35 shows a perspective view of the nozzle from FIG. 34 from the front;

FIG. 36 shows a perspective view of a nozzle variant with four cruciform jet outlet openings from the front;

FIG. 37 shows a plan view of the nozzle from FIG. 36 from the rear;

FIG. 38 shows a perspective view of a nozzle variant with three triangular jet outlet openings and a reinforcing bar pattern from the front;

FIG. 39 shows a plan view of the nozzle from FIG. 38 from the rear;

FIG. 40 shows a perspective view of a nozzle variant with four cruciform jet outlet openings and a weakening pattern on the inner side of the bottom and on the outer side of the bottom from the front;

FIG. 41 shows the perspective longitudinal sectional view from FIG. 6 for the nozzle of FIG. 40;

FIG. 42 shows a plan view of the nozzle of FIGS. 40 and 41 from the rear;

FIG. 43 shows a photographic recording of the bottom region of a nozzle according to FIGS. 6 and 7 from the front in an operating state of the nozzle with the absence of or with a low shower fluid operating pressure;

FIG. 44 shows the photographic recording from FIG. 43 in an operating state of the nozzle at increased shower fluid operating pressure;

FIG. 45 shows a longitudinal sectional view of a front region of the nozzle of FIG. 27 along a line A-A in FIG. 27 in a pressureless initial state of the nozzle;

FIG. 46 shows the view from FIG. 45 in an operating state of the nozzle with a moderately high shower fluid operating pressure;

FIG. 47 shows the view from FIG. 46 in an operating state of the nozzle with an increased shower fluid operating pressure;

FIG. 48 shows the view from FIG. 47 in an operating state of the nozzle with a further increased shower fluid operating pressure;

FIG. 49 shows a characteristic curve graph for illustrating a typical functional relationship between the nozzle internal pressure and the nozzle volume flow for a nozzle according to the invention and for a conventional comparison nozzle;

FIG. 50 shows half a longitudinal sectional view of a shower device with shower jet outlet nozzles according to the invention integrally formed on an elastomeric jet outlet plate;

FIG. 51 shows a perspective plan view of the elastomeric jet outlet plate of the shower device from FIG. 50 from the rear; and

FIG. 52 shows a perspective plan view of the elastomeric jet outlet plate from the front.

### DETAILED DESCRIPTION OF THE DRAWINGS

The embodiments of the invention described herein are not intended to be exhaustive or to limit the invention to precise forms disclosed. Rather, the embodiments selected for description have been chosen to enable one skilled in the art to practice the invention.

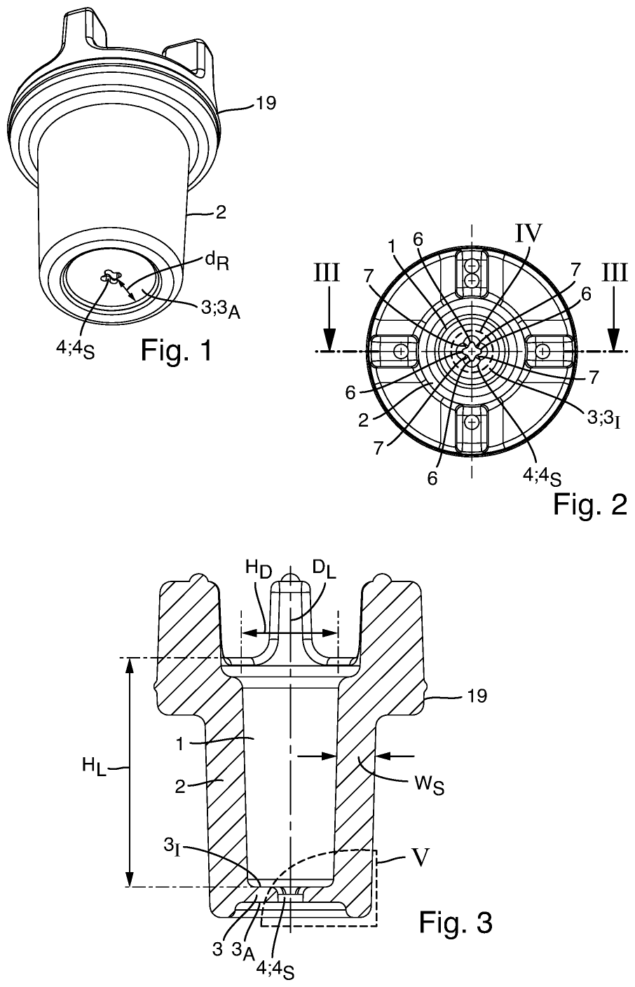

As shown in various embodiments and views in FIGS. 1 to 48, the cup-shaped shower jet outlet nozzle according to the invention comprises a hollow chamber 1, a lateral wall 2 delimiting the hollow chamber 1 transversely to a nozzle longitudinal axis D_{L}, and a bottom 3 delimiting the hollow chamber 1 in the direction of the nozzle longitudinal axis D_{L} on an outlet side. The bottom 3 is made of an elastic material, preferably an elastomeric material, as is known per se to a person skilled in the art for use in shower jet outlet nozzles. The elastomeric material may be, for example, an elastic silicone material, e.g. with a Shore A hardness between 20 and 70.

A jet outlet opening structure 4_{S} is formed in the bottom 3, the jet outlet opening structure comprising one or more jet outlet openings 4 and having an open initial configuration, i.e. at least one of the jet outlet openings 4 is already open in the pressureless initial state, which means that its opening cross-section which is available for the passage of shower fluid, i.e. its open cross-sectional area, is already greater than zero in the pressureless initial state. The bottom 3 is designed, with the jet outlet opening structure 4_{S} thereof, under the effect of a shower fluid operating pressure in the hollow chamber 1, i.e. a nozzle internal pressure, to deform in an elastically resilient manner and thereby to steadily increase the opening cross-section of the jet outlet opening structure 4_{S} with increasing shower fluid operating pressure, wherein this applies at least for values of the shower fluid operating pressure which lie within a prespecified normal operating pressure range, i.e. within a range in which the shower fluid operating pressure or nozzle internal pressure can lie during normal operation of the shower jet outlet nozzle. An overpressure range is to be distinguished from this normal operating pressure range, the overpressure range lying above this normal operating pressure range and the shower fluid operating pressure reaching the overpressure range only when abnormal overpressure operating states occur.

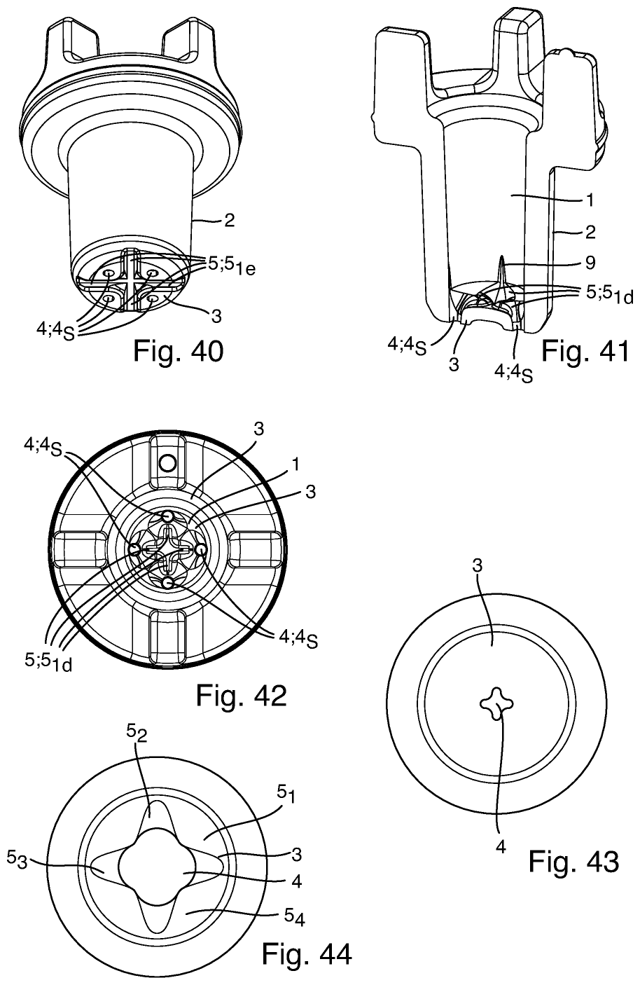

In advantageous embodiments, the jet outlet opening structure 4_{S} is spaced apart from the lateral wall 2, i.e. the one or more jet outlet openings 4 thereof do not extend radially in the bottom up to the lateral wall 2, but rather keep a certain radial distance d_{R} from it, as denoted in a representative manner in FIGS. 1, 35, 36 and 38, and the bottom 3 on an inner side 3_{I} facing the hollow chamber 1 and/or on an outer side 3_{A} facing away from the hollow chamber 1 has a weakening pattern 5 with a lesser wall thickness as compared to an adjacent region of the bottom 3. The weakening pattern 5 is designed to deform in an elastically resilient manner under the effect of the shower fluid operating pressure in the hollow chamber 1. FIGS. 6 to 9, 12 to 19, 25 to 35, 38 and 39 show exemplary embodiments in which the weakening pattern 5 is formed solely on the inner side of the bottom. FIGS. 10 and 11 show an exemplary embodiment in which the weakening pattern 5 is formed solely on the outer side of the bottom. FIGS. 40 to 42 show an exemplary embodiment in which the weakening pattern 5 is formed both on the inner side of the bottom and on the outer side of the bottom.

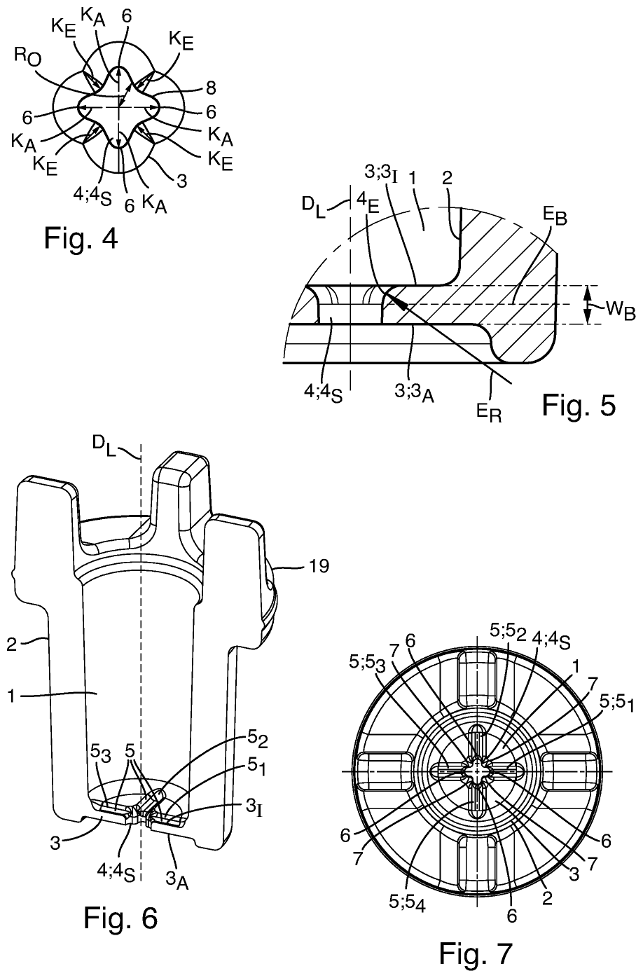

In advantageous embodiments, the single jet outlet opening or at least one of the plurality of jet outlet openings 4 of the jet outlet opening structure 4_{S} has/have an opening radius R_{O} increasing and decreasing alternatingly in the circumferential direction, while forming alternate bulge regions 6 and recess regions 7. The bulge regions 6 each have a rounded shape with a respective minimum bulge curvature radius K_{A} and in the same way the recess regions 7 each have a rounded shape with a respective minimum recess curvature radius K_{E}. In this case, the minimum bulge curvature radii K_{A} and the minimum recess curvature radii K_{E} are each in a range between 0.01 mm and 1 mm, and/or the minimum bulge curvature radii K_{A} are in a size ratio K_{A}/K_{E} between 0.3 and 2.5 to the minimum recess curvature radii K_{E}. Various exemplary embodiments of this kind are shown in FIGS. 1 to 39, wherein the bulge regions 6 and the recess regions 7 are denoted in a representative manner in FIGS. 2, 4, 7, 17, 21 and 39, and the associated minimum curvature radii K_{A}, K_{E} are additionally denoted in FIG. 4. As is clear from FIG. 4 in particular, the radius R_{O} of an opening edge 8 of the jet outlet opening 4 in question therefore changes depending on the circumferential angle, in this case steadily, between a minimum value at the turning point of the respective recess region 7 and a maximum value at the turning point of the respective bulge region 6 with a change gradient which is relatively uniform in accordance with the present minimum curvature radii K_{A}, K_{E}, without sudden changes.

In advantageous embodiments, the single jet outlet opening or at least one of the jet outlet openings 4 of the jet outlet opening structure 4_{S} has a non-planar opening edge 8n which is undulated extending with an axial directional component pointing in a fluid outlet direction F_{A} and counter to the fluid outlet direction F_{A} relative to a plane E_{B} of the bottom 3. In this case, the fluid outlet direction F_{A} is parallel to the nozzle longitudinal axis D_{L}, and the bottom plane E_{B} is perpendicular to the nozzle longitudinal axis D_{L}. An exemplary embodiment of this kind is shown in FIGS. 22 to 24. In other words, the opening edge 8n, as it extends around the circumference, bulges in relation to the remaining region of the bottom 3 alternatingly with an axial directional component counter to the fluid outlet direction F_{A} to the inside into the hollow chamber 1 and with an axial directional component pointing in the fluid outlet direction F_{A} to the outside away from the hollow chamber 1.

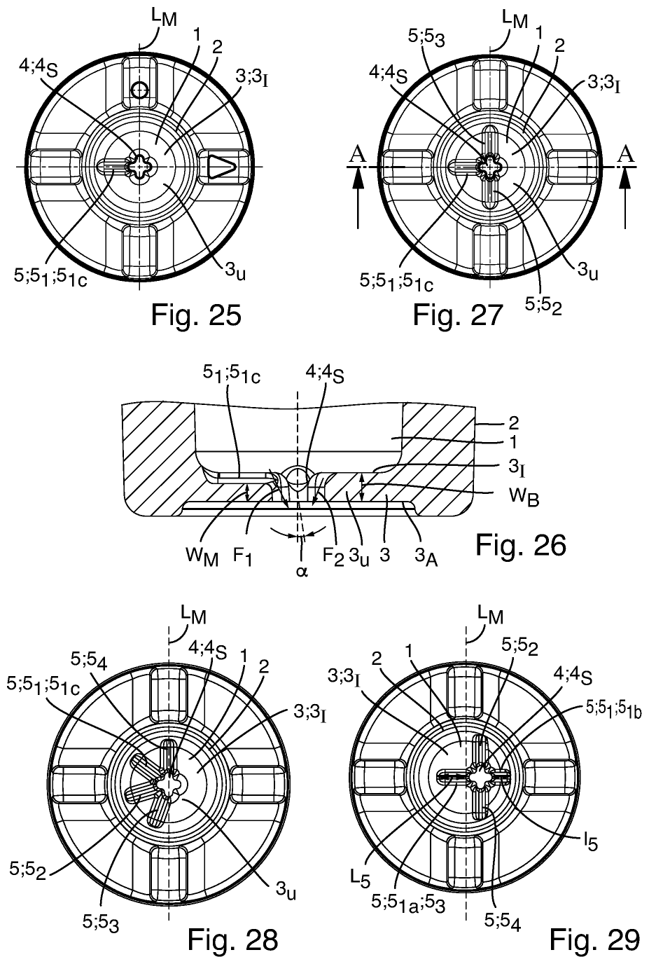

In advantageous embodiments, the weakening pattern 5 includes at least one weakening zone 5₁ in the bottom 3, which extends from an associated jet outlet opening 4 of the jet outlet opening structure 4_{S} away from the latter. Corresponding exemplary embodiments are shown in FIGS. 6 to 19, 25 to 35 and 45 to 48. Here, in the variants of FIGS. 6 to 9, 12 to 17 and 28 to 35 four weakening zones 5₁ to 5₄ on the inner side of the bottom, in the variant of FIGS. 10 and 11 four weakening zones 5₁ to 5₄ on the outer side of the bottom, in the variant of FIGS. 18 and 19 five weakening zones 5₁ to 5₅ on the inner side of the bottom, in the variant of FIGS. 25 and 26 a single weakening zone 5₁ on the inner side of the bottom, and in the variant of FIGS. 27 and 45 to 48 three weakening zones 5₁ to 5₃ on the inner side of the bottom are disposed extending away from the respective jet outlet opening 4.

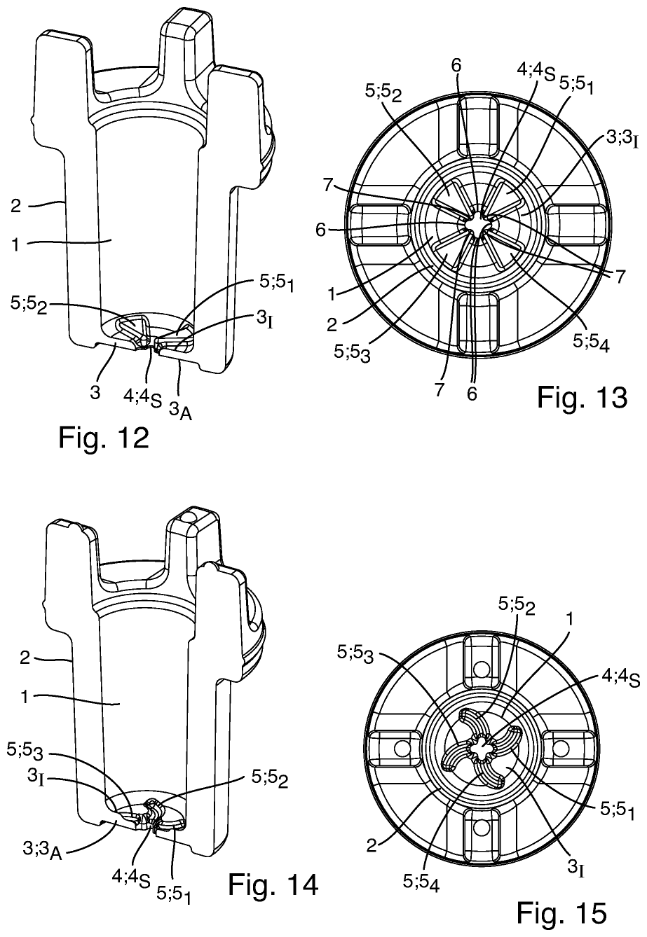

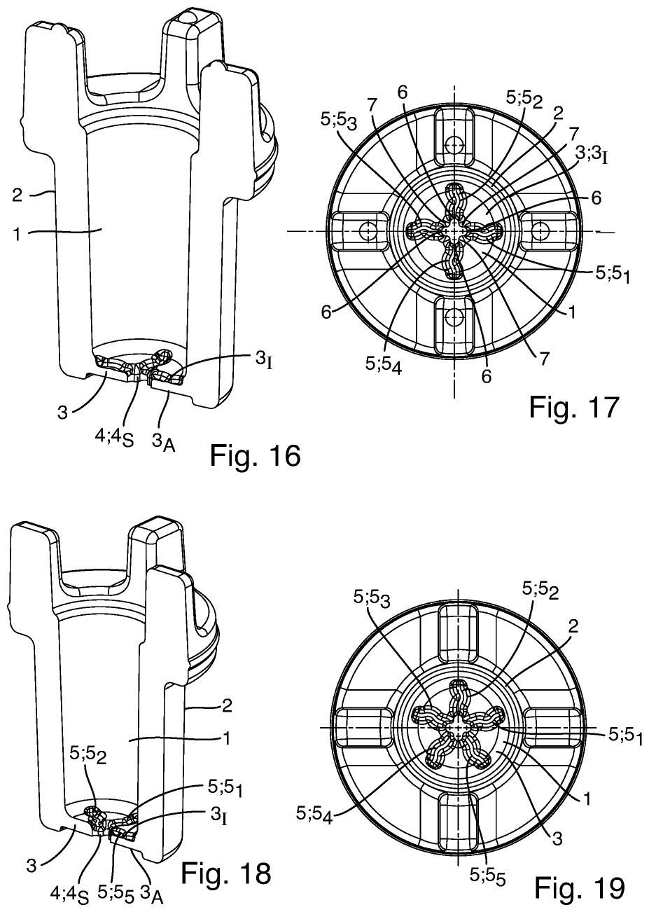

In corresponding implementations, the at least one weakening zone 5₁ in the bottom 3 is a linear weakening zone extending with a radial main directional component, i.e. with a greater directional component in the radial direction of the nozzle than tangentially thereto, in a straight line or single-bent or multiple-bent in undulated lines. FIGS. 6 to 13, 25 to 35 and 38 to 42 show exemplary embodiments in which the respective weakening zone extends in a straight line, wherein it has a shape which widens radially outwards in the circumferential direction in the exemplary embodiment of FIGS. 12 and 13, while the width of the respective weakening zone remains substantially constant along its longitudinal extent in the other exemplary embodiments. FIGS. 14 and 15 show an exemplary embodiment in which the respective linear weakening zone runs single-bent. FIGS. 16 to 19 show two exemplary embodiments in which the respective linear weakening zone extends multiple-bent in undulating lines.

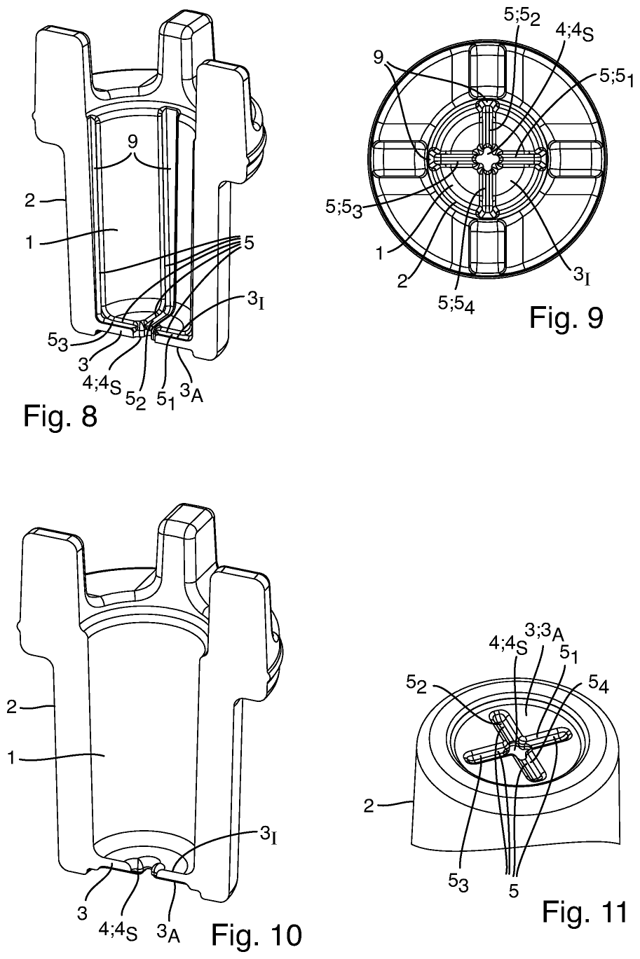

In corresponding implementations, the at least one weakening zone 5₁ in the bottom 3 extends up to the lateral wall 2 and there transitions into a weakening zone 9 in the lateral wall 2. FIGS. 8, 9 and 40 to 42 show exemplary embodiments of this kind, wherein in the example of FIGS. 8 and 9 the weakening zone 9 extends axially along the entire longitudinal extent of the lateral wall 2 on the inner side thereof, while in the example of FIGS. 40 to 42 the weakening zone 9 extends only over a relatively short length adjacent to the bottom 3 in the axial direction on the inner side of the lateral wall 2.

In corresponding implementations, the at least one weakening zone 5₁ in the bottom 3 is a linear weakening zone departing from one of the bulge regions 6 or one of the recess regions 7 of the associated jet outlet opening 4. FIGS. 6 to 11, 14 to 17, 25 to 35, 38 and 39 show exemplary embodiments in which the weakening zones all depart from one of the bulge regions 6. In the exemplary embodiment of FIGS. 12 and 13, the weakening zones all depart from one of the bulge regions 7. In the exemplary embodiments of FIGS. 18, 19 and 28, there is no fixed association of the weakening zones with the bulge or recess regions 6, 7.

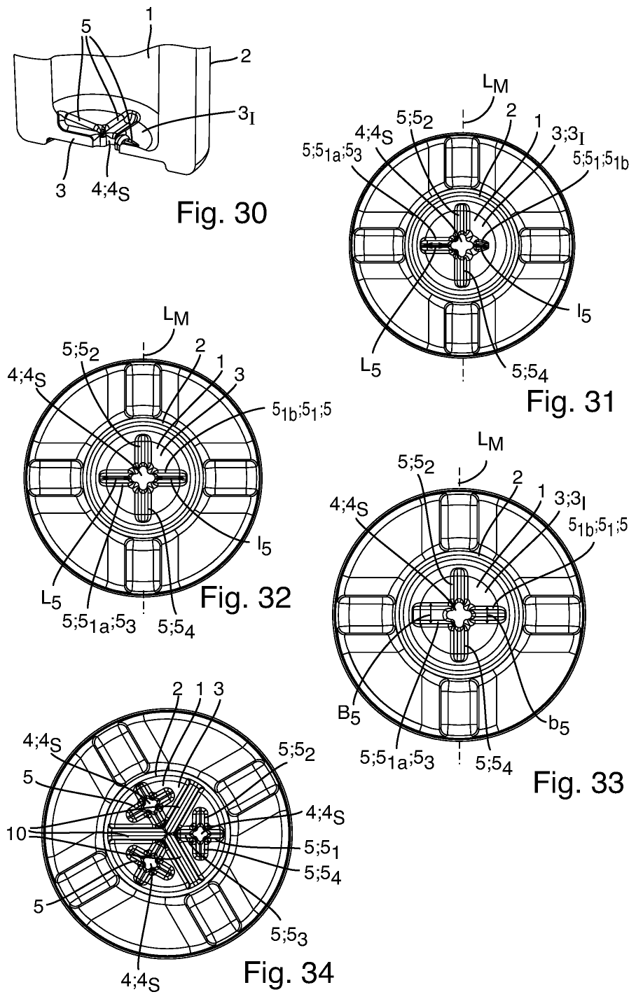

In advantageous embodiments, the bottom 3 for the jet outlet opening 4, away from which opening the at least one weakening zone 5₁ extends, is disposed in a jet angle setting manner. For this purpose, in a first manner of implementation, the one or more weakening zones 5₁ extending away from the jet outlet opening 4 on the inner side 3_{I} of the bottom 3 are disposed in an asymmetric arrangement in a jet angle setting manner relative to a longitudinal central plane L_{M} of the jet outlet opening. Corresponding exemplary embodiments are shown in FIGS. 25 to 33. In a second manner of implementation, which can be realized in addition to or as an alternative to the first manner of implementation, the bottom 3 extends in a manner inclined to the inner side in a jet angle setting manner at least in one region including the jet outlet opening 4. An exemplary embodiment in this respect is illustrated in FIGS. 30 and 31. In a third manner of implementation, which can be provided in addition to or as an alternative to either of the two first-mentioned manners of implementation, the jet outlet opening 4 in the bottom 3 is disposed eccentrical in a jet angle setting manner. An exemplary embodiment in this respect is illustrated in FIG. 29.

In corresponding embodiments, as are illustrated in FIGS. 25 to 33 by way of example, the asymmetric arrangement of the one or more weakening zones extending away from the jet outlet opening 4 on the inner side 3_{I} of the bottom 3 comprises two linear weakening zones 5₁ₐ, 5_{1b} opposed to each other in relation to the longitudinal central plane L_{M} of the jet outlet opening 4 having different lengths and/or different widths, or comprises at least one weakening zone 5_{1c} extending away from the jet outlet opening 4 on the inner side 3_{I} of the bottom 3, with a non-weakened bottom zone 3ᵤ opposed thereto in relation to the longitudinal central plane L_{M} of the jet outlet opening 4. FIGS. 25 to 28 show exemplary embodiments of the last-mentioned type in which at least one weakening zone 5_{1c} extending away from the jet outlet opening 4 is opposite the non-weakened bottom zone 3ᵤ. In the exemplary embodiment of FIG. 33, the two opposed weakening zones 5₁ₐ, 5_{1b} have different widths, specifically the weakening zone 5₁ₐ has a width B₅ and the weakening zone 5_{1b} has a comparatively smaller width b₅. In the exemplary embodiments of FIGS. 29 to 32, the two opposed weakening zones 5₁ₐ, 5_{1b} have different lengths, specifically the weakening zone 5₁ₐ has a length L₅ and the weakening zone 5_{1b} has a comparatively shorter length l₅.

In corresponding embodiments, the weakening pattern 5 includes in each case at least one weakening zone 5_{1d}, 5₁ₑ on the inner side 3_{I} and on the outer side 3_{A} of the bottom 3, wherein the at least one weakening zone 5_{1d} on the inner side 3_{I} is disposed offset in relation to the at least one weakening zone 5₁ₑ on the outer side 3_{A} in the circumferential direction of the bottom 3. A corresponding exemplary embodiment is illustrated in FIGS. 40 to 42, wherein by way of example in each case four linear, straight weakening zones 5_{1d} offset through 90° in relation to one another are provided on the bottom inner side 3_{I} and four linear, straight weakening zones 5₁ₑ disposed offset through in each case 45° in relation thereto are provided on the bottom outer side 3_{A}. In this case, the weakening zones 5₁ₑ on the outer side of the bottom each extend radially in the region between two adjacent jet outlet openings 4, while the weakening zones 5_{1d} on the inner side of the bottom each extend radially from the bottom central region to one of the jet outlet openings 4. In the same way, in alternative embodiments, e.g. only in each case two or three or more than four linear, straight or bent weakening zones can be provided on the outer side of the bottom and on the inner side of the bottom, preferably with equidistant circumferential spacings and preferably offset in relation to one another centrally in the circumferential direction.

In advantageous embodiments, the single jet outlet opening or at least one of the plurality of jet outlet openings 4 of the jet outlet opening structure 4_{S} has a rounded polygonal cross-sectional base shape, the rounded corner regions thereof being formed by the bulge regions 6. FIGS. 1 to 21 and 25 to 37 illustrate exemplary embodiments in this respect with a square, i.e. cruciform, cross-sectional base shape, while FIGS. 38 and 39 show an exemplary embodiment with a triangular cross-sectional base shape of the jet outlet openings 4.

In advantageous implementations, the single jet outlet opening or at least one of the plurality of jet outlet openings 4 of the jet outlet opening structure 4_{S} has an outlet equivalent diameter in a range of 0.2 mm to 1.2 mm, as is the case in the exemplary embodiments shown. This is to be understood to mean that the jet outlet opening 4 in question has, in its pressureless initial state, a free passage cross-section for the shower fluid which is the same size as that of an imaginary circular jet outlet opening with a diameter in the specified range, i.e. between 0.2 mm and 1.2 mm. In particular in the region of smaller diameters, the jet outlet opening 4 is suitable e.g. for providing a fine/needle jet as the shower jet.

In advantageous implementations, a wall thickness W_{B}, denoted in a representative manner in FIGS. 5 and 26, of the bottom 3 outside any weakening pattern is, as in the examples shown, in the range of 0.1 mm to 1 mm. This dimensioning proves expedient in respect of a desired stability of the bottom 3 for the vast majority of applications.

In advantageous implementations, a minimum wall thickness W_{M}, denoted in a representative manner in FIG. 26, of the bottom 3 in the region of the weakening pattern 5 is, as in the examples shown, between one fifth and half of the wall thickness W_{B} of the bottom 3 outside the weakening pattern 5. This proves to be optimum matching of the weakened and non-weakened zones of the bottom 3 in respect of the desired fluid pressure-dependent deformability of the bottom 3 for a large number of applications for the purpose of increasing the size of the opening cross-section of the respective jet outlet opening 4 with increasing fluid pressure.

In advantageous implementations, the single jet outlet opening or at least one of the plurality of jet outlet openings 4 of the jet outlet opening structure 4_{S} has a funnel-type quadrant-shaped rounded inlet region 4_{E}, as is denoted in a representative manner in FIG. 5 and is preferably provided in all of the examples shown. This inlet region 4_{E} has an inlet curvature radius E_{R}, likewise denoted in FIG. 5, between 0.1 mm and 0.3 mm. It is evident that this measure aids low-turbulence flow of the shower fluid out of the hollow chamber 1 into the jet outlet opening 4, this contributing to stabilizing the jet shape of the shower jet exiting from the jet outlet opening 4 to the outside.

In advantageous implementations, an inner diameter H_{D}, denoted in FIG. 3, of the hollow chamber 1, as in the examples shown, is in a range of 1.5 mm to 4 mm, wherein the hollow chamber inner diameter H_{D} preferably remains substantially constant along the longitudinal extent of the nozzle in accordance with the cup shape of the shower jet outlet nozzle and corresponds to the inner diameter of the bottom 3.

In advantageous implementations, an axial length H_{L}, likewise denoted in a representative manner in FIG. 3, of the hollow chamber 1, as in the examples shown, is in a range of 4 mm to 8 mm. The hollow chamber length H_{L} which is usually considerably greater than the hollow chamber inner diameter H_{D} can foster a desired channelling of the shower fluid entering the nozzle before it passes through the one or more jet outlet openings 4 to the outside.

In advantageous implementations, a wall thickness W_{S}, denoted in a representative manner in FIG. 3, of the lateral wall 2 of the nozzle outside the weakening pattern 5 is, as in the examples shown, at least 0.8 mm. This dimensioning of the lateral wall 2 is preferably matched to the other dimensions of the nozzle in such a way that, under the effect of the shower fluid operating pressure, provided that this remains within the normal operating pressure range, substantially only the bottom 3 deforms in an elastically resilient manner, while the lateral wall 2 does not noticeably deform, i.e. remains substantially rigid, given these pressure values of the shower fluid operating pressure in the hollow chamber 1. This then has the effect that, in the case of the shower jet outlet nozzle according to the invention, only the bottom 3 thereof significantly deforms under the effect of the shower fluid operating pressure, which is within the normal operating pressure range, in the hollow chamber 1, without the lateral wall 2 thereof also deforming e.g. in a bulging manner at the same time. In this case, significant deformation is to be understood to mean deformation to such an extent that it traceably or measurably influences the flow of the shower fluid through the nozzle.

In corresponding embodiments, the jet outlet opening structure 4_{S} comprises a plurality of jet outlet openings 4 and the bottom 3 comprises a reinforcing bar pattern 10 having a greater wall thickness as compared to an adjacent region of the bottom 3, wherein the reinforcing bar pattern 10 subdivides the bottom into a plurality of bottom partial regions, in which in each case at least one of the jet outlet openings 4 is disposed, or extends with one respective reinforcing bar end up to a corresponding one of the jet outlet openings 4. Exemplary embodiments of this kind are illustrated in FIGS. 34 to 39.

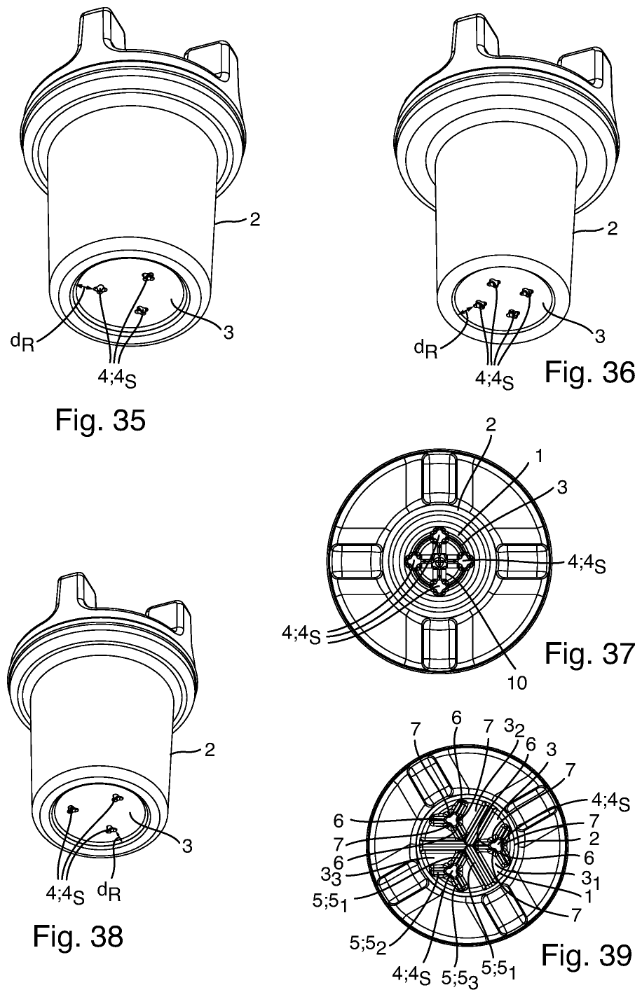

In the exemplary embodiment of FIGS. 34 to 35, the reinforcing bar pattern 10 is formed in a star shape with three radial bars by way of which the bottom 3 is subdivided into three bottom partial regions 3₁, 3₂, 3₃ in which in each case one of the in this case three cruciform jet outlet openings 4 is disposed. The weakening pattern 5 with the in each case four linear, straight weakening zones 5₁ to 5₄ is associated with each of these jet outlet openings 4. The reinforcing bar pattern 10 has a stabilizing effect on the bottom 3 and limits the deformation of the bottom 3 to a prespecifiable, desired amount. The exemplary embodiment of FIGS. 38 and 39 corresponds to that of FIGS. 34 and 35 with the modification that, for the jet outlet openings 4, those with a rounded triangular, rather than square, cross-sectional base shape are used and the in each case associated weakening pattern 5 includes the three linear, straight weakening zones 5₁, 5₂, 5₃ extending radially outwards from the bulge regions 6 of the jet outlet opening 4. In the exemplary embodiment of FIGS. 36 and 37, the reinforcing bar pattern 10 has a cross shape comprising reinforcing bars which are arranged in a central region of the bottom 3, wherein one of in this case four cruciform jet outlet openings 4 adjoins each bar end.

The measures shown and explained above, on their own and in combination, contribute to a specific, advantageous shower jet behaviour of the shower jet outlet nozzle. In the example of FIGS. 1 to 5, the elastically deformable bottom 3 has only the one, cruciform jet outlet opening 4 in the central region of the bottom 3 for this purpose. In the exemplary embodiment of FIGS. 6 and 7, the weakening pattern 5 on the bottom is additionally provided with the four linear, straight weakening zones 5₁ to 5₄ on the inside of the bottom. This facilitates the deformation of the bottom 3 at the given shower fluid operating pressure or nozzle internal pressure in the hollow chamber 1. In the exemplary embodiment of FIGS. 8 and 9, each of the four linear, straight weakening zones 5₁ to 5₄ on the inner side of the bottom continue through the additional linear, straight weakening zone 9 in the nozzle lateral wall 2, which weakening zone extends over the entire hollow chamber length or lateral wall length. The weakening zones 9 in the lateral wall 2 can reduce the stabilizing effect of the lateral wall 2 on the bottom 3 to a desired extent, this permitting greater deformation of the bottom 3 at the given pressure as required.

In the exemplary embodiment of FIGS. 10 and 11, the weakening pattern 5 is disposed on the outer side of the bottom instead of the inner side of the bottom. In the exemplary embodiment of FIGS. 12 and 13, the weakening zones 5₁ to 5₄ on the inner side of the bottom open out in a wedge-shaped manner into the recess regions 7 instead of into the bulge regions 6, as in the exemplary embodiments of FIGS. 6 to 11. In the exemplary embodiment of FIGS. 14 and 15, the weakening zones 5₁ to 5₄ extend in a single-curved or bent manner. As a result, they have a greater length with the same radial extent, and this can facilitate the deformation of the bottom 3 as required. In the example of FIGS. 16 and 17, the linear weakening zones 5₁ to 5₄ extend in undulating lines, as a result of which the length thereof can be further increased given the same radial extent, and this can further foster the deformation behaviour of the bottom 3. In the exemplary embodiment of FIGS. 18 and 19, the weakening pattern 5 includes, instead of the four weakening zones 5₁ to 5₄ extending from the bulge regions 6 of the example of FIGS. 16 and 17, the five weakening zones 5₁ to 5₅ in undulating lines, as a result of which the bottom 3 can be deformed even more readily as required.

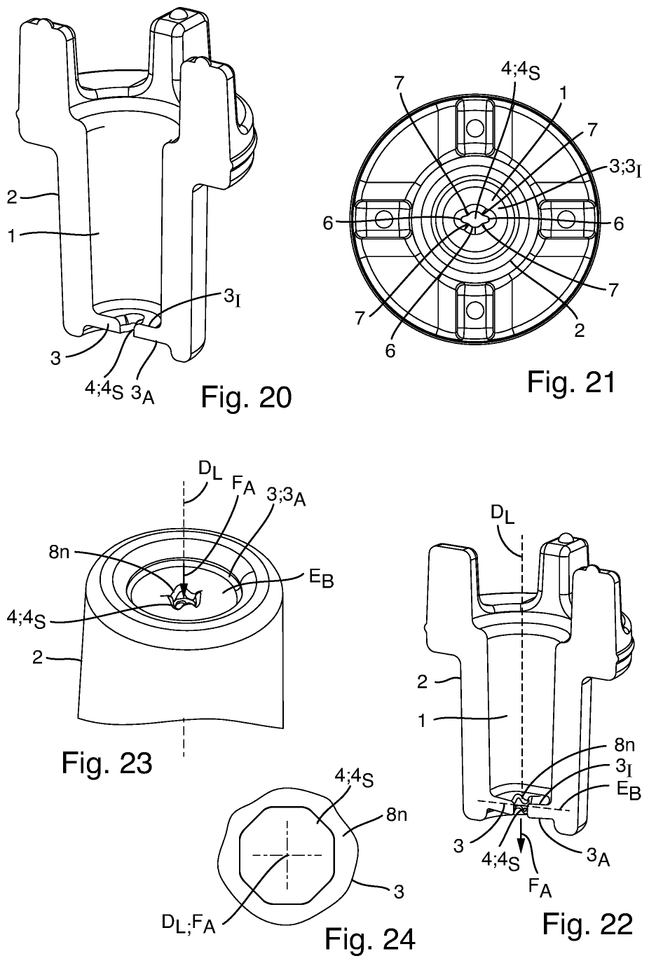

In the exemplary embodiment of FIGS. 20 and 21, the jet outlet opening 4 has an elongate, rounded cross shape with a relatively long cross axis extending from left to right in FIG. 21 and a relatively short cross axis extending from bottom to top in FIG. 21, while in the other cruciform jet outlet openings 4 shown the two cross axes are of equal length. Therefore, the jet shape of the shower jet exiting from the jet outlet opening 4 can be correspondingly modified as required. In addition, the elongate cross shape facilitates the deformation of the bottom 3 in this region.

In the exemplary embodiment of FIGS. 22 to 24, the shaping of the jet outlet opening 4 with the undulating, non-planar opening edge 8n allows a comparatively smooth deformation behaviour of the bottom 3 in the opening region. Since the opening edge 8n folded in an undulating shape can increasingly unfold with an increasing fluid pressure effect, a relatively large deformation path is available for the opening edge 8n, wherein the bottom 3 with the opening edge 8n can deform or spread out to a relatively great extent to the outside.

Owing to a corresponding design of the weakening pattern 5, the exemplary embodiments of FIGS. 25 to 33 allow a respectively desired jet angle setting, in the case of which the shower jet does not exit from the jet outlet opening 4 in question and therefore leave the nozzle strictly parallel to the nozzle longitudinal axis D_{L}, but rather does so at an acute setting angle with respect to the nozzle longitudinal axis D_{L}. For this purpose, the weakening pattern 5 is preferably disposed asymmetrically with respect to the mentioned longitudinal central axis L_{M} of the nozzle, be it due to asymmetrical distribution of the associated weakening zones, as in the examples of FIGS. 25 to 28, or due to different dimensioning of corresponding weakening zones, as in the examples of FIGS. 32 and 33, or due to an oblique course of the bottom 3 on the inner side 3_{I} thereof, as in the example of FIGS. 30 and 31. The oblique course is formed in the manner of an oblique plane which extends obliquely from top left to bottom right in the view of FIG. 30. It goes without saying that the said measures can also be combined with one another in any desired manner as required.

FIG. 26 illustrates the effect of the jet angle setting for the example of FIG. 27 in more detail. The sectional view of FIG. 26 shows the linear weakening zone 5₁ or 5_{1c} to the left of the jet outlet opening 4, the non-weakened bottom region 3u being situated opposite to the right of the said linear weakening zone. The linear weakening zone 5₁ or 5_{1c} forms a channel-like recess on the bottom inner side 3_{I}, with the result that the shower fluid under operating pressure passes along the linear weakening zone 5_{1c} at a somewhat higher flow rate into the jet outlet opening 4 than in the opposite, non-weakened bottom region 3u. This is symbolized in FIG. 26 by a relatively long flow arrow F₁ in the weakening zone 5_{1c} and a relatively short flow arrow F₂ in the non-weakened bottom region 3u. This effect has the result that a resulting flow direction, symbolized by a flow arrow F₃ in FIG. 26, is produced for the shower fluid exiting from the jet outlet opening 4 which is dominated to a somewhat greater extent by the relatively large transverse component of the greater flow rate on the side of the weakening zone 5_{1c} than by the relatively small transverse component of the lower flow rate in the non-weakened bottom region 3u, so that the shower jet does not exit from the jet outlet opening 4 and therefore the nozzle strictly parallel to the nozzle longitudinal axis D_{L}, but rather with a set jet direction which forms a setting angle α, indicated in FIG. 26, with the nozzle longitudinal axis D_{L}.

Therefore, a respectively desired jet outlet direction of the shower jet from the nozzle can be provided due to corresponding dimensioning of the bottom 3 and in particular the weakening pattern 5. The setting angle α can be selected in a relatively wide range, wherein a setting angle in the range of greater than 0° and less than approximately 20° to 30° is usually preferred, e.g. often an angle between 5° and 15°.

In the exemplary embodiments of FIGS. 29 to 33, the setting angle effect is not based on a non-weakened bottom region being situated opposite a weakening zone, but rather on weakening zones of unequal extent being situated opposite each other, wherein this is additionally amplified by the oblique position of the bottom inner side 3_{I} in the example of FIGS. 30 and 31.

The exemplary embodiments of FIGS. 34 to 42 in each case have a plurality of jet outlet openings 4 in the bottom 3, wherein it may be expedient for the purpose of bottom stabilization to provide the reinforcing bar pattern 10, as in the examples of FIGS. 34 to 39. In the exemplary embodiment of FIGS. 40 to 42, circular jet outlet openings 4 are used, wherein the bottom is designed in a comparatively readily deformable manner there by way of the mentioned weakening zones of the weakening pattern 5 being formed both on the outer side of the bottom and on the inner side of the bottom.

FIGS. 43 and 44 illustrate, for a nozzle according to the invention produced with the design of FIGS. 6 and 7, the advantageous bottom deformation behaviour of the nozzle with a considerable increase in the size of the effective opening cross-section of the jet outlet opening 4 with increasing shower fluid operating pressure, i.e. nozzle internal pressure in the hollow chamber 1.

FIG. 43 shows the nozzle in its pressureless initial state with the rounded cross shape of the central jet outlet opening 4, as also shown in FIGS. 6 and 7. FIG. 44 shows the nozzle, in the same view, under an operating pressure loading of approximately 1.0 bar, this already being a pressure value generally somewhat above the normal operating pressure range. It can be clearly seen how the bottom 3 has deformed in a bulging manner to the outside, as a result of which the opening cross-section of the jet outlet opening 4 has greatly increased, e.g. to approximately five times to six times its cross-section in the pressureless state of FIG. 43. FIG. 44 also shows the four linear, radial weakening zones 5₁ to 5₄ which render possible this considerable and in this case fully elastically reversible deformation of the bottom 3. Furthermore, it is clear from FIGS. 43 and 44 that the cross shape of the jet outlet opening 4 is substantially maintained with increasing deformation of the bottom 3, i.e. there is no fundamental change in shape of the passage cross-section of the jet outlet opening 4 with different operating pressures.

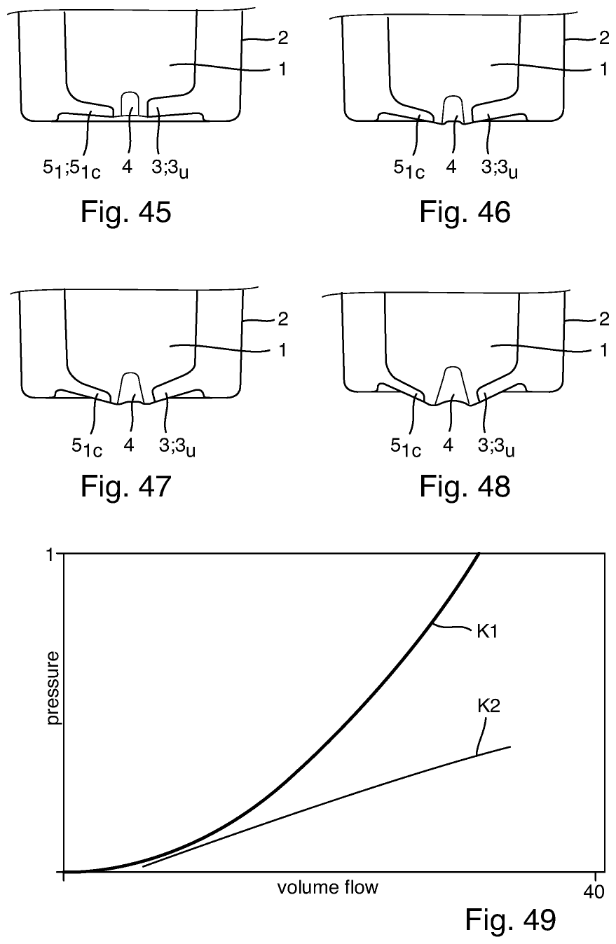

FIGS. 45 to 48 illustrate that the nozzle according to the invention furthermore has the advantage that the bottom 3 deforms virtually fully symmetrically along the circumference of the jet outlet opening 4 both in the possible weakening zones and in the non-weakened bottom regions. This has the further advantageous effect that the deformation of the bottom 3, which increases with increasing fluid operating pressure, does not cause any appreciable change in the jet angle at which the shower jet leaves the jet outlet opening 4 and therefore the nozzle, irrespective of whether the shower jet exits parallel to the nozzle longitudinal axis D_{L} or at an oblique angle or setting angle in relation thereto.

For this purpose, FIGS. 45 to 48 show the nozzle with the design of FIG. 26 in operating states with different fluid operating pressures. FIG. 45 illustrates the operating situation in the pressureless state or with an at least extremely low fluid operating pressure which does not result in any appreciable deformation of the bottom 3. FIG. 46 shows the nozzle at a somewhat increased fluid pressure. In comparison to FIG. 45, it can be seen how the bottom 3 has already deformed in a slightly outwardly bulging manner. In this case, the bottom 3 bulges outwards to a substantially equal extent at the edge of the jet outlet opening 4 firstly in the weakening zone 5_{1c} and secondly in the non-weakened bottom region 3u. This can also be seen for the operating states with respectively further increased fluid operating pressure according to FIGS. 47 and 48. Even with the high operating fluid pressure of FIG. 48, the protrusion of the bottom 3 to the outside which increases with a higher pressure remains largely symmetrical, i.e. the protrusion is substantially equal along the entire circumferential edge of the jet outlet opening 4, both in the weakening zone 5_{1c} and in the non-weakened bottom region 3u.

FIG. 49 qualitatively illustrates the particularly advantageous behaviour of the shower jet outlet nozzle according to the invention at different fluid operating pressures in a characteristic curve graph of the shower fluid operating pressure, i.e. of the shower fluid pressure prevailing in the interior of the hollow chamber 1 of the nozzle preferably in the vicinity of the respective jet outlet opening 4 during operation of the nozzle, as a function of the volume flow, i.e. of the volume of shower fluid passing through the jet outlet opening structure 4_{S} of the nozzle per unit time. A characteristic curve K1 shows the behaviour of a conventional shower jet outlet nozzle not deforming under the effect of the fluid operating pressure which therefore exhibits no noticeably expanding deformation of its jet outlet opening structure with increasing volume flow.

The nozzle internal pressure, which as stated is specifically the pressure directly upstream of the respective jet outlet opening, increases substantially quadratically in the case of this conventional nozzle, as is clear from the profile of the characteristic curve K1. In contrast to this, the nozzle internal pressure in the case of the nozzle according to the invention rises significantly less sharply with increasing volume flow, the associated pressure behaviour as a function of the volume flow being qualitatively illustrated by a characteristic curve K2 in FIG. 49. This expedient nozzle behaviour is based on the property of the nozzle according to the invention that the bottom thereof deforms with increasing shower fluid operating pressure and as a result the opening cross-section of its jet outlet opening structure 4_{S} significantly increases. This allows relatively high volume flows with a relatively low nozzle internal pressure. Therefore, the nozzle according to the invention allows e.g. volume flows of up to approximately 30 litres/min with a nozzle internal pressure of at most approximately 0.4 bar and preferably even only up to approximately 0.2 bar in accordance with the characteristic curve K2 given a corresponding design. To put it another way, the nozzle according to the invention allows relatively high volume flows during operation even at relatively low shower fluid operating pressure or nozzle internal pressure. In yet other words, the nozzle according to the invention allows relatively high volume flows even in the normal operating pressure range up to approximately 0.4 bar or approximately 0.5 bar. This makes the nozzle according to the invention particularly suitable for flexible use in applications with different available fluid operating pressures. Therefore, the nozzle according to the invention can be used with an identical design for various regions or countries which provide different fluid supply pressure levels, whereas specially adapted nozzles of different design usually have to be used here.

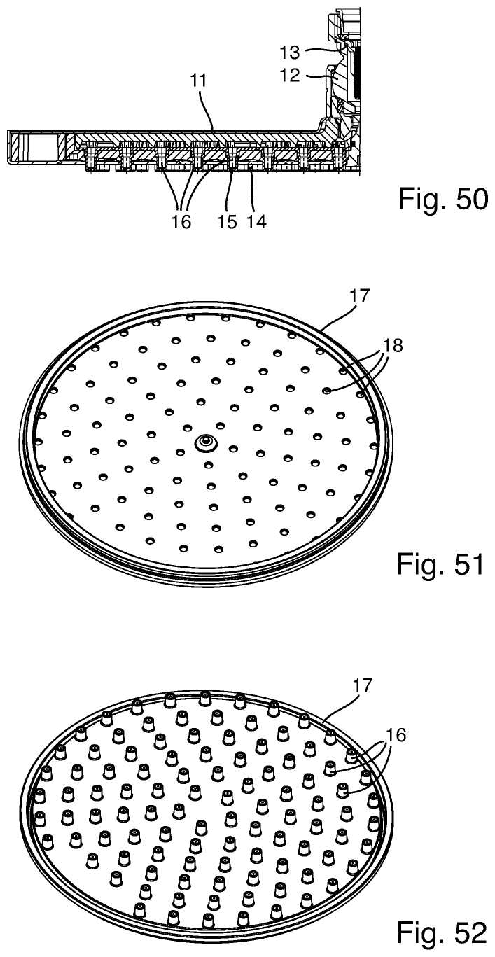

The shower device according to the invention has at least one shower jet outlet nozzle according to the invention and may be, in particular, a sanitary shower device. FIG. 50 illustrates an example in which the shower device has a flat design known per se, as is used for sanitary overhead shower devices for example. The shower device shown has a shower device housing 11 which is held in a pivotable manner at an inlet port 13 by means of a ball joint 12. At the outlet end, the shower device housing 11 terminates with a jet disc 14 which is provided with jet disc openings 15. A cup-shaped shower jet outlet nozzle 16 according to the invention is disposed in each jet disc opening 15 as a jet outlet element.

In the exemplary embodiment of the shower device shown, the shower jet outlet nozzles 16 according to the invention are integrally formed on a jet outlet plate 17 which is shown as a single component in FIGS. 51 and 52 and, by way of a front side shown in FIG. 52, bears against a rear side or inner side of the jet disc 14. The jet outlet plate 17 is made from an elastic material, such as a customary silicone-based elastomeric material, and is therefore also referred to as a jet outlet mat. The shower jet outlet nozzles 16 according to the invention are integrally formed on the jet outlet plate 17. FIG. 51 shows the jet outlet plate 17 with its rear side, from which the shower jet outlet nozzles 16 with the inlet regions 18 thereof open out. In alternative shower device designs, the shower jet outlet nozzles according to the invention are fitted as individual elements, for which purpose they have suitable foot regions. In the exemplary embodiments of FIGS. 1 to 48 shown, the shower jet outlet nozzles are in each case formed with an optional foot region 19, as denoted in a representative manner in FIGS. 1, 3 and 6.

As is clear from the exemplary embodiments shown and the further exemplary embodiments explained above, the invention provides a shower jet outlet nozzle which has particular advantages in respect of the shower jet characteristics that can be provided by it with different shower fluid operating pressure levels and is preferably suitable for providing a relatively fine shower jet. Owing to the bulging deformation of the bottom, the formation of lime deposits can be reduced and any lime deposits formed can automatically fall off again. The nozzle according to the invention is suitable for use in any desired sanitary and non-sanitary shower devices.

Although the invention has been described in detailed with reference to preferred embodiments, variations and modifications exist within the spirit and scope of the invention as described and defined in the following claims.

1. A cup-shaped shower jet outlet nozzle, comprising:
a hollow chamber;
a lateral wall delimiting the hollow chamber transversely to a nozzle longitudinal axis;
a bottom delimiting the hollow chamber in the direction of the nozzle longitudinal axis on an outlet side, which bottom is made of an elastic material and in which a jet outlet opening structure including at least one jet outlet opening and having an open initial configuration is provided;
wherein the bottom is configured, with the jet outlet opening structure thereof, under the effect of a shower fluid operating pressure in the hollow chamber, to deform in an elastically resilient manner and thereby to steadily increase an opening cross-section of the jet outlet opening structure with increasing shower fluid operating pressure within a normal operating pressure range; and
wherein the jet outlet opening structure is spaced apart from the lateral wall, and the bottom on at least one of an inner side and an outer side has a weakening pattern with a lesser wall thickness as compared to an adjacent region of the bottom, the weakening pattern being configured to deform in an elastically resilient manner under the effect of the fluid operating pressure in the hollow chamber.

2. The shower jet outlet nozzle according to claim 1, wherein the weakening pattern includes at least one weakening zone in the bottom, which extends from an associated jet outlet opening of the jet outlet opening structure away from the latter.

3. The shower jet outlet nozzle according to claim 2, wherein the weakening zone in the bottom is a linear weakening zone extending with a radial main directional component in a straight line or single-bent or multiple-bent in undulated lines, or the weakening zone in the bottom extends up to the lateral wall and there transitions into a weakening zone in the lateral wall.

4. The shower jet outlet nozzle according to claim 2, wherein:
the bottom for the jet outlet opening, away from which opening the at least one weakening zone extends, is disposed in a jet angle setting manner, wherein the at least one weakening zone extending away from the jet outlet opening on the inner side of the bottom are disposed in an asymmetric arrangement in a jet angle setting manner relative to a longitudinal central plane of the jet outlet opening; or
the bottom, at least in a region including the jet outlet opening, extends inclined on the inner side in a jet angle setting manner; or
the jet outlet opening in the bottom is disposed eccentrical in a jet angle setting manner.

5. The shower jet outlet nozzle according to claim 4, wherein the asymmetric arrangement of the one or more weakening zones extending away from the jet outlet opening on the inner side of the bottom comprises two linear weakening zones opposed to each other in relation to the longitudinal central plane of the jet outlet opening having at least one of different lengths and different widths, or comprises a weakening zone extending away from the jet outlet opening on the inner side of the bottom, with a non-weakening bottom zone opposed thereto in relation to the longitudinal central plane of the jet outlet opening.

6. The shower jet outlet nozzle according to claim 1, wherein the weakening pattern includes in each case at least one weakening zone on the inner side and on the outer side of the bottom, wherein the at least one weakening zone on the inner side is disposed offset in relation to the at least one weakening zone on the outer side in the circumferential direction of the bottom.

7. The shower jet outlet nozzle according to claim 1, wherein:
the at least one jet outlet opening of the jet outlet opening structure has an outlet equivalent diameter in a range of 0.2 mm to 1.2 mm; or
a wall thickness of the bottom outside the weakening pattern is in a range of 0.1 mm to 1 mm; or
a minimum wall thickness of the bottom in the region of the weakening pattern is between one fifth and half of a wall thickness of the bottom outside the weakening pattern; or
the at least one jet outlet opening of the jet outlet opening structure has a funnel-type quadrant-shaped rounded inlet region which has an inlet curvature radius between 0.1 mm and 0.3 mm; or
a hollow chamber inner diameter is in a range of 1.5 mm to 4 mm; or
a hollow chamber length is in a range of 4 mm to 8 mm; or
a wall thickness of the lateral wall outside the weakening pattern is at least 0.8 mm.

8. The shower jet outlet nozzle according to claim 1, wherein the jet outlet opening structure comprises a plurality of jet outlet openings and the bottom comprises a reinforcing bar pattern having a greater wall thickness as compared to an adjacent region of the bottom, wherein the reinforcing bar pattern subdivides the bottom into a plurality of bottom partial regions, in which in each case at least one of the jet outlet openings is disposed, or extends with one respective reinforcing bar end up to a corresponding one of the jet outlet openings.

9. A cup-shaped shower jet outlet nozzle, comprising:
a hollow chamber;
a lateral wall delimiting the hollow chamber transversely to a nozzle longitudinal axis;
a bottom delimiting the hollow chamber in the direction of the nozzle longitudinal axis on an outlet side, which bottom is made of an elastic material and in which a jet outlet opening structure including at least one jet outlet opening and having an open initial configuration is provided;
wherein the bottom is configured, with the jet outlet opening structure thereof, under the effect of a shower fluid operating pressure in the hollow chamber, to deform in an elastically resilient manner and thereby to steadily increase an opening cross-section of the jet outlet opening structure with increasing shower fluid operating pressure within a normal operating pressure range; and
wherein the at least one jet outlet opening of the jet outlet opening structure includes an opening radius increasing and decreasing alternatingly in the circumferential direction, while forming alternate bulge regions and recess regions, wherein the bulge regions each have a rounded shape with a respective minimum bulge curvature radius and the recess regions each have a rounded shape with a respective minimum recess curvature radius, wherein the minimum bulge curvature radii and the minimum recess curvature radii are in a range between 0.01 mm and 1 mm or wherein the minimum bulge curvature radii are in a size ratio between 0.3 and 2.5 to the minimum recess curvature radii.

10. The shower jet outlet nozzle according to claim 9, wherein the jet outlet opening structure is spaced apart from the lateral wall, and the bottom on at least one of an inner side and an outer side has a weakening pattern with a lesser wall thickness as compared to an adjacent region of the bottom, the weakening pattern being designed to deform in an elastically resilient manner under the effect of the fluid operating pressure in the hollow chamber.

11. The shower jet outlet nozzle according to claim 10, wherein the weakening pattern includes at least one weakening zone in the bottom, which extends from an associated jet outlet opening of the jet outlet opening structure away from the latter, wherein the weakening zone in the bottom is a linear weakening zone departing from one of the bulge regions or one of the recess regions of the associated jet outlet opening.

12. The shower jet outlet nozzle according to claim 9, wherein the at least one jet outlet opening of the jet outlet opening structure has a rounded polygonal cross-sectional base shape, wherein the bulge regions are rounded corner regions of the polygonal cross-sectional base shape.

13. The shower jet outlet nozzle according to claim 9, wherein:
the at least one jet outlet opening of the jet outlet opening structure has an outlet equivalent diameter in a range of 0.2 mm to 1.2 mm; or
the at least one jet outlet opening of the jet outlet opening structure has a funnel-type quadrant-shaped rounded inlet region which has an inlet curvature radius between 0.1 mm and 0.3 mm; or
a hollow chamber inner diameter is in a range of 1.5 mm to 4 mm; or
a hollow chamber length is in a range of 4 mm to 8 mm.

14. The shower jet outlet nozzle according to claim 9, wherein the jet outlet opening structure comprises a plurality of jet outlet openings and the bottom comprises a reinforcing bar pattern having a greater wall thickness as compared to an adjacent region of the bottom, wherein the reinforcing bar pattern subdivides the bottom into a plurality of bottom partial regions, in which in each case at least one of the jet outlet openings is disposed, or extends with one respective reinforcing bar end up to a corresponding one of the jet outlet openings.

15. A cup-shaped shower jet outlet nozzle, comprising:
a hollow chamber;
a lateral wall delimiting the hollow chamber transversely to a nozzle longitudinal axis;
a bottom delimiting the hollow chamber in the direction of the nozzle longitudinal axis on an outlet side, which bottom is made of an elastic material and in which a jet outlet opening structure including at least one jet outlet opening and having an open initial configuration is provided;
wherein the bottom is configured, with the jet outlet opening structure thereof, under the effect of a shower fluid operating pressure in the hollow chamber, to deform in an elastically resilient manner and thereby to steadily increase an opening cross-section of the jet outlet opening structure with increasing shower fluid operating pressure within a normal operating pressure range; and
wherein the at least one jet outlet opening of the jet outlet opening structure includes a non-planar opening edge which is undulated extending with an axial directional component pointing in a fluid outlet direction and counter to the fluid outlet direction relative to a plane of the bottom.

16. The shower jet outlet nozzle according to claim 15, wherein the jet outlet opening structure is spaced apart from the lateral wall, and the bottom on at least one of an inner side and an outer side has a weakening pattern with a lesser wall thickness as compared to an adjacent region of the bottom, the weakening pattern being designed to deform in an elastically resilient manner under the effect of the fluid operating pressure in the hollow chamber.

17. The shower jet outlet nozzle according to claim 15, wherein the at least one jet outlet opening of the jet outlet opening structure includes an opening radius increasing and decreasing alternatingly in the circumferential direction, while forming alternate bulge regions and recess regions, wherein the bulge regions each have a rounded shape with a respective minimum bulge curvature radius and the recess regions each have a rounded shape with a respective minimum recess curvature radius, wherein the minimum bulge curvature radii and the minimum recess curvature radii are in a range between 0.01 mm and 1 mm, or wherein the minimum bulge curvature radii are in a size ratio between 0.3 and 2.5 to the minimum recess curvature radii

18. The shower jet outlet nozzle according to claim 16, wherein the weakening pattern includes at least one weakening zone in the bottom, which extends from an associated jet outlet opening of the jet outlet opening structure away from the latter.

19. The shower jet outlet nozzle according to claim 18, wherein:
the weakening zone in the bottom is a linear weakening zone extending with a radial main directional component in a straight line or single-bent or multiple-bent in undulated lines; or
the weakening zone in the bottom extends up to the lateral wall and there transitions into a weakening zone in the lateral wall; or
the at least one jet outlet opening of the jet outlet opening structure has an outlet equivalent diameter in a range of 0.2 mm to 1.2 mm; or
a wall thickness of the bottom outside the weakening pattern is in a range of 0.1 mm to 1 mm; or
a minimum wall thickness of the bottom in the region of the weakening pattern is between one fifth and half of a wall thickness of the bottom outside the weakening pattern; or
the at least one jet outlet opening of the jet outlet opening structure has a funnel-type quadrant-shaped rounded inlet region which has an inlet curvature radius between 0.1 mm and 0.3 mm; or
a hollow chamber inner diameter is in a range of 1.5 mm to 4 mm; or
a hollow chamber length is in a range of 4 mm to 8 mm; or
a wall thickness of the lateral wall outside the weakening pattern is at least 0.8 mm.

20. The shower jet outlet nozzle according to claim 15, wherein the at least one jet outlet opening of the jet outlet opening structure has a rounded polygonal cross-sectional base shape, and wherein the bulge regions are rounded corner regions of the polygonal cross-sectional base shape.
